(19) United States
(12) Patent Application Publication
(10) Pub. No.: US 2016/0195718 A1
(43) Pub. Date: Jul. 7, 2016

(54) SYSTEM, METHOD, AND APPARATUS FOR DISPLAYING AN IMAGE USING MULTIPLE DIFFUSERS

(71) Applicant: Avegant Corporation, Ann Arbor, MI (US)

(72) Inventor: Allan Thomas Evans, Redwood City, CA (US)

(21) Appl. No.: 14/590,963

(22) Filed: Jan. 6, 2015

(51) Int. Cl. G02B 27/01; G02B 5/02

(52) U.S. Cl. CPC G02B 27/0101; G02B 27/017; G02B 5/0294; G02B 5/0278; G02B 2027/0114; G02B 2027/0138; G02B 2027/0145

(57) ABSTRACT

A system (100), method (900), and apparatus (110) for displaying an image (880). The system (100) can utilize two or more diffusers (282) separated by a gap (290) to reduce the coherence of the light (800) used in the display of the image (880). The diffusers (282) can be diffuser film (283), diffuser paper (284), diffuser glass (285), diffuser coatings (286), or virtually any form of multi-textured surfaces (287). The gap (290) between two diffusers (282) can be an air gap (291), a glass gap (292), or some other form of space that is different from the diffusers (282) and at least semi-transparent. The system (100) can be embodied as a DLP system (141), an LCD system (142), an LCOS system (143), a system (100) utilizing virtually any type of display technology (140).

### RELATED APPLICATIONS

This utility patent application both (i) claims priority to and (ii) incorporates by reference in its entirety, the provisional patent application titled “NEAR-EYE DISPLAY APPARATUS AND METHOD” (Ser. No. 61/924,209) that was filed on Jan. 6, 2014.

### BACKGROUND OF THE INVENTION

The invention is system, method, and apparatus (collectively the “system”) for displaying images. More specifically, the invention is a system that uses multiple diffusers.

The explosion in computer technology and consumer electronics has exponentially increased the number of electronic devices with the capability of displaying an image. Such devices can vary substantially in terms of scale, the underlying technology used to construct and display the image, and other important attributes. Some display screens are passive like the screen at a movie theater. Other display screens are active, such as a television, computer monitor, or smart phone. Some display technologies are utilized at a very large scale, such as the scoreboard at a football stadium or the advertising screens in Time Square. Other display technologies are used in a highly personal context, such as VRD (virtual retinal display) display device worn on the head of a user. There are a wide number of different underlying technologies that can be used to display an image. Common examples of display technologies include but are not limited to DLP (digital light processing), LCD (liquid-crystal display), and LCOS (liquid crystal on silicon).

One commonality between the various display technologies is the use of light as an input to the process for displaying an image. The display of an image requires light and the image displayed by such technologies is comprised of modulated light. Light is an important input to a process which culminates in the display of an image. The purpose of the various components of any display technology is to generate, modify, and/or direct light in such a manner as to display the desired image in the desired way. Such processing must be performed at high speeds in order for the results to be perceived in a truly real time manner by a human being. One common context for image displays is video, where images are displayed in rapid succession to convey a sense of moving images. Conventional frame rates for video content currently vary between 24 FPS (frames per second) and 30 FPS.

The light used by conventional display technologies is at least partially coherent. “Coherence” is a term of art in physics. Coherent light is light in which the phases of all electromagnetic waves at each point on a line normal to the direction of the beam are identical. A less technical way to think of coherent light is in terms of light waves that are “in step” with each other, i.e. moving in a parallel path like a marching band marching on a football field.

In the real world, light is substantially non-coherent. The light that encounters our eyes originates from different sources and bounces off different objects at different angles. Non-coherent light looks real and natural to human beings because non-coherent light is what we are used to seeing.

In contrast to our everyday experiences, display technologies utilize partially coherently light. Such display technologies use a common light source to supply the process with light. The light used to display an image originates from the same source and such light travels the same path. Display technologies such as DLP, LCD, LCOS, and other approaches to image generation thus involve the use of partially coherent light. Despite the fact that partially coherent light appears unnatural to human beings, the conventional teaching of image display technologies fully embraces the use of partially coherent light because such light as a practical matter is closely tied to the concept of optical efficiency.

The prior art affirmatively teaches away from the use of two or more diffusers in the display of an image because the use of multiple diffusers has negative implications for optical efficiency. Prior art teachings in display technologies such as DLP (digital light processing), LCD (liquid-crystal display), LCOS (liquid crystal on silicon), and other display technologies appear uniform in the consensus that the use of partially coherent light is a necessary and worthwhile price for maintaining a high level of optical efficiency. Vendors of various display components pepper their marketing materials with references to high optical efficiency. To purposely embrace lower optical efficiency is a concept that is at odds with technologists, salespersons, and marketing strategies. It is precisely that drive to sustain high levels of optical efficiency that traps product designers, manufacturers, and ultimately individual users into experiencing visual displays that suffer from relatively high coherence, relatively unnatural looking light, and relatively poor color mixtures.

It would be desirable for a system to diffuse light two or more times so that the resulting image is comprised of light with relatively reduced coherence.

### SUMMARY OF THE INVENTION

The invention is system, method, and apparatus (collectively the “system”) for displaying images. More specifically, the invention is a system that uses multiple diffusers to diffuse the light that is formed into the displayed image. The use of two or more diffusers reduces the coherence of the light use to create the displayed image. Such light appears more natural, and exhibits superior mixtures of color.

The two or more diffusers can be comprised of a wide variety of different materials and shaped and positioned within a wide range of potential configurations.

A gap between two diffusers can similarly be implemented in a wide variety of different ways. In some instances, the gap is simply empty space. In other contexts, the gap is an at least substantially transparent object positioned between the two diffusers.

### BRIEF DESCRIPTION OF THE DRAWINGS

Many features and inventive aspects of the system are illustrated in the various drawings described briefly below. All components illustrated in the drawings below and associated with element numbers are named and described in Table 1 provided in the Detailed Description section.

FIG. 1a is a block diagram illustrating an example of a double diffuser configuration. A system uses two diffusers separated by a gap to twice diffuse the light from the light source that is used to form the image.

FIG. 1b is a block diagram illustrating an example of a system that includes an illumination assembly for supplying light to an imaging assembly, and an imaging assembly for forming an image using the light from the illumination assembly. A diffuser subassembly within the illumination assembly diffuses the light two or more times to enhance the quality of the image provided by the system to the user.

FIG. 1c is wave diagram illustrating an example of at least substantially coherent light.

FIG. 1d is a wave diagram illustrating an example of at least substantially non-coherent light.

FIG. 1e is a vector diagram illustrating an example of at least substantially coherent light.

FIG. 1f is a vector diagram illustrating an example of at least substantially non-coherent light.

FIG. 1g is a line diagram illustrating an example of the life cycle of light utilized by the system, beginning with a light generated by a light source and ending with the image that is made accessible to one or more users. Partially coherent light is generated by the light source, but the multiple diffusers reduce the coherence of the light before it is formed into an image made accessible to users.

FIG. 1h is a block diagram illustrating an example of the different types of light that can be created and/or utilized by the system.

FIG. 1i is a block diagram illustrating an example of the different types of light metrics that can differentiate the light utilized by the system.

FIG. 1j is a flow chart diagram illustrating an example of a process for displaying an image using light that has been diffused two or more times.

FIG. 1k is a hierarchy diagram illustrating an example of different types of diffusers.

FIG. 1l is a hierarchy diagram illustrating an example of different types of gaps.

FIG. 2a is a block diagram illustrating an example of different assemblies, components, and light that can be present in the operation of the system.

FIG. 2b is a block diagram similar to FIG. 2a, except that the disclosed system also includes a projection assembly.

FIG. 2c is a hierarchy diagram illustrating an example of different components that can be included in an illumination assembly.

FIG. 2d is a hierarchy diagram illustrating an example of different components that can be included in an imaging assembly.

FIG. 2e is a hierarchy diagram illustrating an example of different components that can be included in a projection assembly.

FIG. 2f is a block diagram illustrating examples of different types of supporting components that can be included in the structure and function of the system.

FIG. 3a is a block diagram illustrating an example of a DLP system using multiple diffusers of light.

FIG. 3b is a block diagram illustrating a more detailed example of a DLP system.

FIG. 3c is a block diagram illustrating an example of an LCD system using multiple diffusers of light.

FIG. 3d is a block diagram illustrating an example of an LCOS system using multiple diffusers of light.

FIG. 4a is diagram of a perspective view of a VRD apparatus embodiment of the system.

FIG. 4b is environmental diagram illustrating an example of a side view of a user wearing a VRD apparatus embodying the system.

FIG. 4c is an architectural diagram illustrating an example of the components that can be used in a VRD apparatus.

FIG. 5a is a hierarchy diagram illustrating an example of the different categories of display systems that the innovative system can be potentially be implemented in, ranging from giant systems such as stadium scoreboards to VRD visor systems that project visual images directly on the retina of an individual user.

FIG. 5b is a hierarchy diagram illustrating an example of different categories of display apparatuses that close mirrors the systems of FIG. 5a.

FIG. 5c is a perspective view diagram illustrating an example of user wearing a VRD visor apparatus 116.

FIG. 5d is hierarchy diagram illustrating an example of different display/projection technologies that can be incorporated into the system, i.e. benefit from the use of two diffusers separated by a gap.

FIG. 5e is a hierarchy diagram illustrating an example of different operating modes of the system pertaining to immersion and augmentation.

FIG. 5f is a hierarchy diagram illustrating an example of different operating modes of the system pertaining to the use of sensors to detect attributes of the user and/or the user's use of the system.

FIG. 5g is a hierarchy diagram illustrating an example of different categories of system implementation based on whether or not the device(s) are integrated with media player components.

FIG. 5h is hierarchy diagram illustrating an example of two roles or types of users, a viewer of an image and an operator of the system.

FIG. 5i is a hierarchy diagram illustrating an example of different attributes that can be associated with media content.

FIG. 5j is a hierarchy diagram illustrating examples of different contexts of images.

### DETAILED DESCRIPTION

The invention is system, method, and apparatus (collectively the “system”) for displaying images. More specifically, the invention is a system that uses two or more diffusers separated by a gap to reduce the coherence of light used in the display of the image. Such a configuration can result in more natural looking light, as well as in an enhanced mixture of color in the image displayed to one or more users. Light is an important input in any displayed image, and by enhancing the quality of the light used to create the image, the quality of the image accessed by users is similarly enhanced. The use of two or more diffusers can be implemented using a wide variety of different components and configurations. The inventive approach can also be used in conjunction with virtually any type of display technology.

### I. Overview

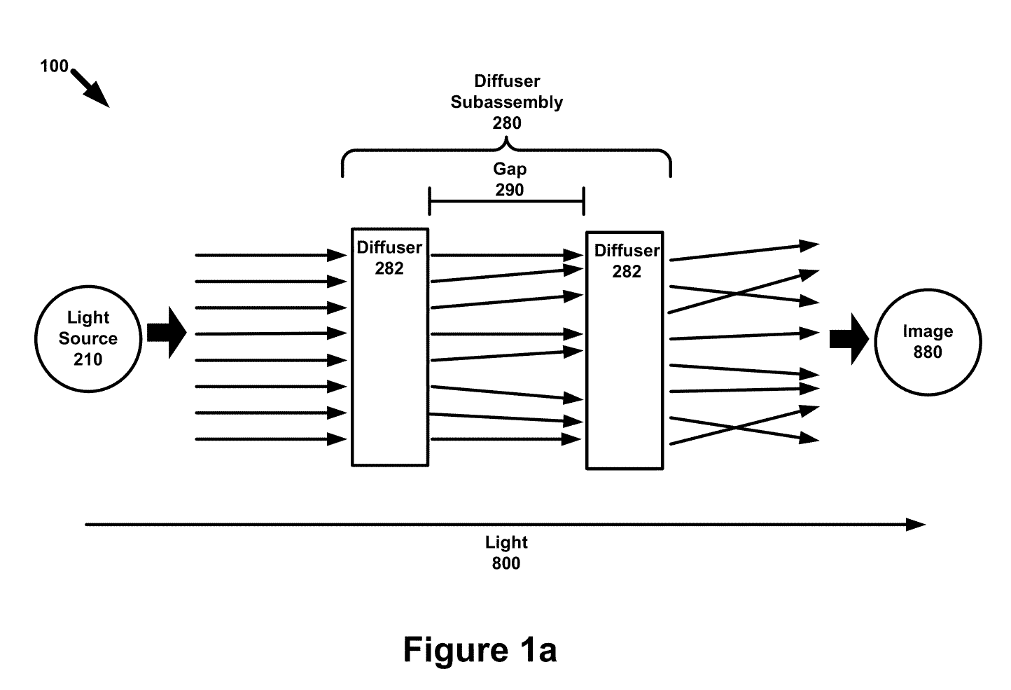

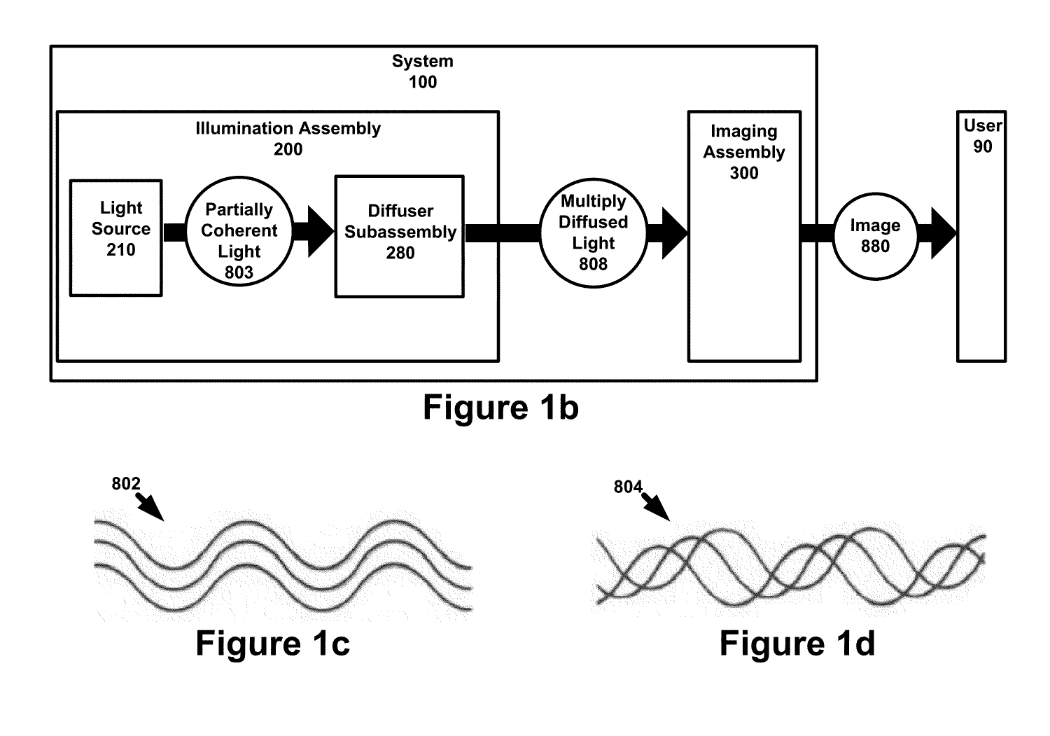

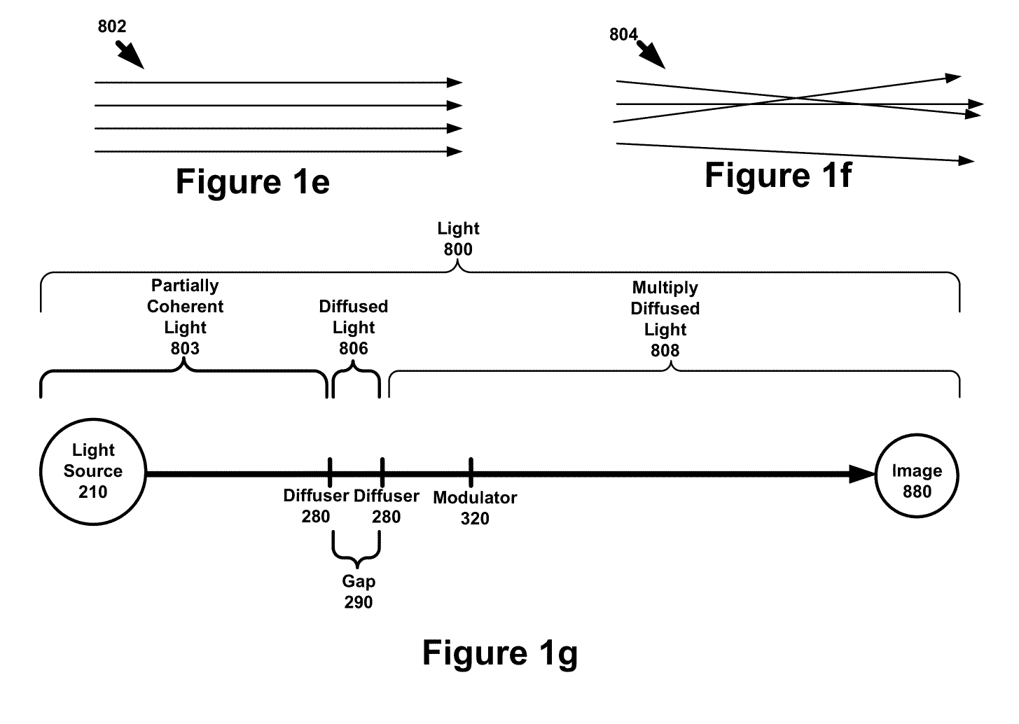

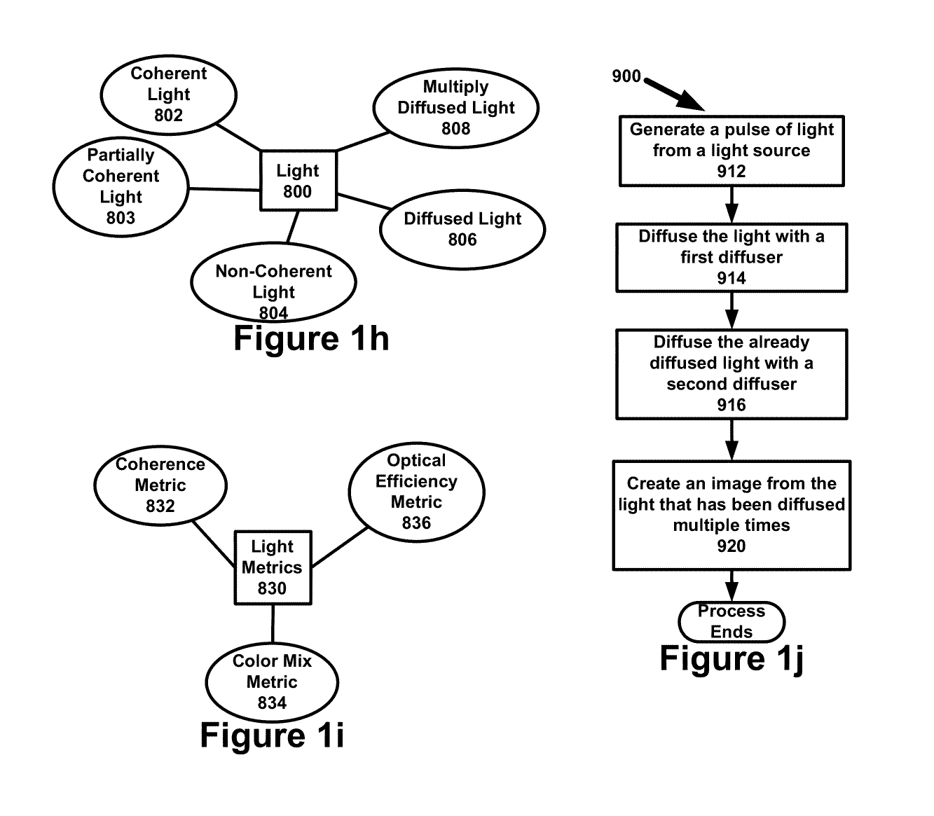

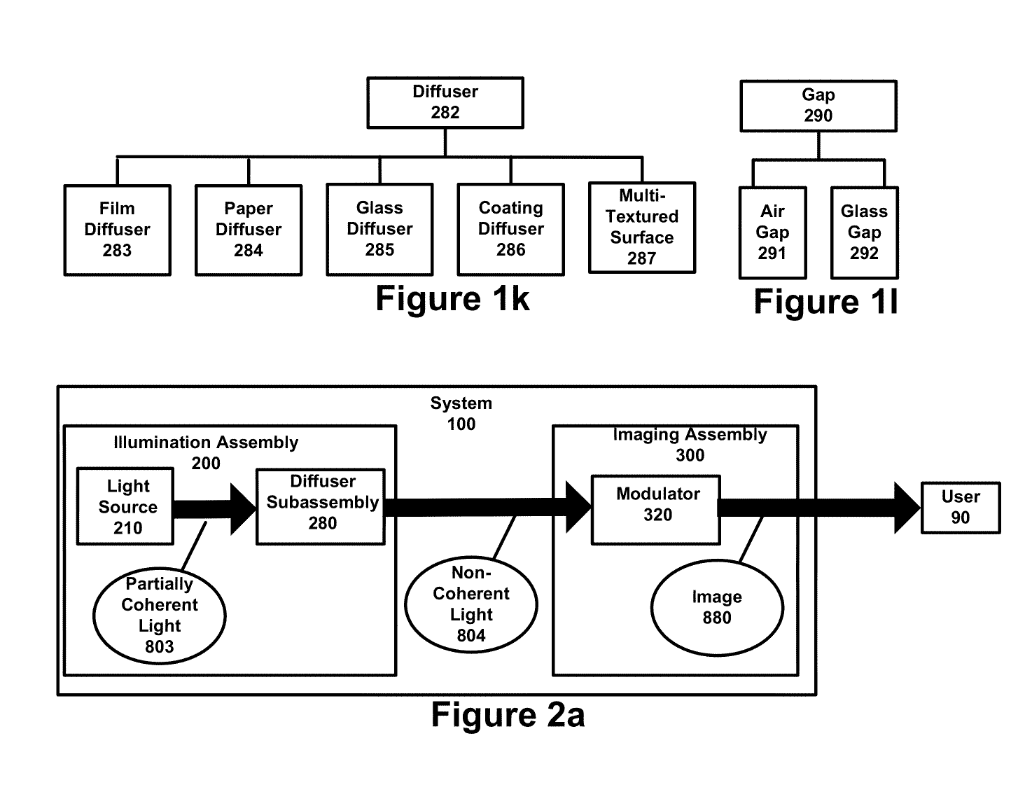

FIG. 1a is a block diagram illustrating a partial example of a system 100 that displays an image 880 using light generated from a light source 210 that is diffused more than one time. The system 100 can be implemented using a wide variety of different display technologies, including but not limited to DLP (digital light processing), LCD (liquid-crystal display), and LCOS (liquid crystal on silicon) technologies. The system 100 can be implemented using virtually any type of display technology that can be used to display an image 880 using light 800 supplied by a light source 210.

The system 100 uses two or more diffusers 282 to diffuse light 800 that originates from a light source 210. After passing through the two diffusers 282 and the gap 290, the light 800 is supplied to the other aspects of the system 100 that are used to form the image 880. Between the two diffusers 282 is a gap 290. The diffusers 282 and gap 290 can be collectively referred to as a diffuser subassembly 280. The diffuser assembly 280 can be implemented in a wide variety of different ways that enhance the quality of the image 880 generated by the system 100.

The benefit of using multiple diffusers 280 separated by a gap 290 is that the light 800 in the resulting image 880 will appear more natural looking relative to other display technologies and configuration. The system 100 can also produce an image 880 with an enhanced mixture of color relative to other electronic display technologies.

FIG. 1b is a block diagram illustrating additional components of the system 100. As illustrated in FIG. 1b, the system 100 can be used to display an image 880 to a user 90. The image 880 made accessible to a user 90 originates from the partially coherent light 803 that is created or generated by the light source 210. The partially coherent light 803 is subject to two or more diffusions by the diffuser subassembly 280. The light 800 conveyed to the imaging assembly 300 is the multiply diffused light 808 from the diffuser subassembly 280, not the partially coherent light 803 generated by the light source 210. The imaging assembly 300 uses the multiply diffused light 808 to form an image 880 that is made accessible to the user 90.

Light 800 is an important “raw material” for any display technology, including the system 100. As illustrated in FIGS. 1a and 1b, light 800 is supplied by the light source 210. The light source 210 generates the light 800 that ultimately makes up the image 880 that is displayed by the system 100. At some point between the light source 210 and the resulting image 880 is a diffuser subassembly 280 that enhances the quality of the light 800 used to construct the image 880.

A. Light

Any display technology needs light 800 in order to display an image 880. Although light 880 moves quickly through the system 100 before leaving the boundaries of the system 100, the supply of light 800 is nonetheless a critical component of the system 100. The system 100 can be used to provide a superior image 880 relative to the prior art because the light 800 utilized by the system 100 to create the image 880 is superior to the light 800 used in prior art technologies. Instead of fashioning the image 880 from partially coherent light 803, the system 100 fashions the image 880 from non-coherent light 804 that has been diffused 2 or more times, i.e. multiply diffused light 808. Such light possess enhanced attributes in comparison to the partially coherent light utilized by conventional display technologies.

1. Coherent Light is not Optimal Light

The light utilized by the system 100 is superior to the light utilized in prior art display technologies because the light utilized by the system 100 is less coherent than the light utilized by prior art display technologies. The enhanced multiply diffused light 808 supplied by the illumination assembly 200 to the imaging assembly 300 is more desirable for the purposes of fashioning an image 808 than the light used by prior art display technologies.

The term “coherent light” has a specific meaning in the fields of optoelectronics and physics. Coherent light is “light in which the phases of all electromagnetic waves at each point on a line normal to the direction of the beam are identical.” A less technical way to think of coherent light is in terms of light waves that are “in step” with each other, i.e. moving in a parallel path like a marching band marching on a football field. The concept of coherent light is easier for the laymen to understand visually than through words. FIG. 1c is a wave diagram illustrating an example of coherent light 802. FIG. 1d is a wave diagram illustrating an example of non-coherent light 804. The waves in FIG. 1c are in perfect parallel with each other, in contrast the waves in FIG. 1d. FIG. 1e is a vector diagram illustrating an example of different rays of coherent light 802. As illustrated in FIG. 1f, the rays of coherent light 802 are travelling identical paths in a parallel fashion. In contrast to FIG. 1f, the non-coherent light 804 of Figure if moves in non-identical and non-parallel directions.

2. Coherent Light, Partially Coherent Light and Non-Coherent Light

Like many attributes in science and engineering, the term “coherence” is a concept understood to exist in a continuum of varying degrees of magnitude. Just as “hot” means different ranges of temperature when discussing the weather that it does when smelting metal, the term coherence is similarly contextual. With respect to the system 100, the concept of coherency is very much a relative one. The use of two or more diffusers 282 to diffuse light 800 will result in light 800 that is materially less coherent than when one or no diffusers 282 are utilized in that same configuration.

A laser generates truly coherent light 802. Other light sources will generate light that is less coherent than laser light even if no diffusers are used. However, such light is still sufficiently coherent to appear unnatural looking to the human eye, and thus such light can be characterized as “partially coherent light” 803. Light that is diffused two or more times still has some magnitude of coherency to it, but such light can be fairly characterized as “non-coherent light” 804.

The coherent light 802 illustrated in FIGS. 1c and 1e is the magnitude of coherence that one would see in a laser, not a LED or other more common source of illumination. Such illustrations would be exaggerations of coherency in most contexts unless a laser is used as the source of illumination. However, these illustrations are an effective way to communicate what the concept of coherency means.

Regardless of the type of display technology being implemented and the type of light source used to supply the light, the light 800 that is utilized by conventional prior art electronic displays is at least partially coherent light 803. The pathway of light from a prior art light source to the prior art image is too short and too uniform to sufficiently reduce the coherence of the light such that it would appear natural looking to the user 90.

In contrast to conventional display technologies, the light that has been encountered by human beings on the planet earth since the days on which people first lived on the planet is comprised of non-coherent light 804. Non-coherent light 804 is more natural looking than partially coherent light 803 or coherent light 802. In the real world, light is constantly bouncing off things, changing directions, etc. This is true for lighting outside that originates from the sun as well as for man-made lighting both indoors and out. Human beings are used to seeing a world populated predominantly by non-coherent light 804 unless what is being viewed is an electronic display such as a movie screen, television set, computer monitor, or smart phone.

One of the features of partially coherent light 803 reaching the eye is “speckle”, which is caused by wave fronts actually interfering with each other in the cells of the retina of the eye 92. The constructive and destructive interference can create a grainy pattern in the resulting image. This phenomenon is easily seen with a laser pointer, but it is also visible with relatively lower coherence (i.e. partially coherent light 803) in rear-projection DLP TVs and other similar applications. Light sources 210 that are small and narrow (directionally closer to a laser) are particularly susceptible to such interference. The higher gain (narrower viewing angle) of the screen, the worse the phenomenon tends to be.

3. The System as a Transformer of Light

In describing the functionality of the system 100 and its components, it is helpful to think of the system 100 as a transformer of light. Different components and processes of the system 100 transform light from one type of light into another type of light. The improvements/transformations of light are what make the implementation of the system 100 desirable for users 90. The system 100 transforms light supplied by a light source 210 that is ultimately fashioned into an image 880 that is made accessible to one or more users 90.

The system 100 can be described in terms of various components used to create light and then modulate the created light into the form of the visual image 200 that is disclosed to the user 90. From the standpoint of the system 100, the lifecycle of light 800 begins at a light source 210 and ends with the display of the visual image 880. Light moves quickly, and any display technology will involve a high number of light cycling. During the cycle from “creation” by the light source 210 and the “final” destination of the image 880 where it can be accessed by a user 90, the system 100 processes light 800 in ways that transform the light 800. Light 800 is a raw material that is transformed in the display process of the system 100 in a manner that is analogous to the transformation of raw materials in a physical manufacturing process.

FIG. 1g is a line diagram illustrating the lifespan of light 800 used by the system 100, i.e. one cycle of light 800 originating from its “creation” by a light source 210 through to the “final” destination (from the standpoint of the system 100) of the image 200 displayed by a user 90. Light 880 is generated by a light source 210 in the illumination assembly 200. That light 800 is subject to various components and processes until the light is embodied in a visual image 880 that is displayed by the system 100.

Light 800 leaves the light source 210 as partially coherent light 803. The partially coherent light 803 becomes diffused light 806 after passing through a diffuser 282. The diffused light 806 becomes multiply diffused light 808 after it passes through the second diffuser 282. The system 100 can use two or more diffusers 282, with each two diffusers 282 separated by a gap 290. The gap 290 can be advantageous in facilitating the ability of the light 800 to move around prior to the next round of diffusion. The multiply diffused light 806 is ultimately sent to the imaging assembly 300 which includes a modulator 320 for shaping the incoming multiply diffused light 808 into the image 880 that is displayed to the user.

FIG. 1h is a block diagram illustrating an example of the different types of light 800 that can be created and/or utilized by the system 100. Partially coherent light 803 is the light supplied by the light source 210. Coherent light 802 is the light supplied by a laser or similar type of light source 210. Non-coherent light 804 is the light 800 that results from two of more diffusions by the diffusion subassembly 280. Diffused light 806 is light 800 that has passed through a diffuser 282. Multiply diffused light 808 is light 800 that has passed through two or more diffusers 282 separated by one or more gaps 290.

4. Light Metrics

Light 800 is an important component to the system 100. The advantages to users 90 in using the system 100 are grounded in the nature of the light 800 used to display the images 880. Images 880 generated by the system 100 appear more natural because of the nature of the light 800 used to generate the image 880 as an output. Similarly, the color mixture of the images 880 displayed by the system 100 are more desirable to users 90 than prior art images because the light 800 used to construct the image 880 possesses more desirable attributes than the partially coherent light 803 of the prior art.

The advantages discussed above sound somewhat subjective, but the qualities that make light coherent or not can be described in mathematics and measurements that are subject to objective validation and characterization. FIG. 1g is a block diagram illustrating an example of different metrics 830 pertaining to light 800. Those metrics can include a coherence metric 832, a color mix metric 834, and an optical efficiency metric 836.

a. Coherence Metric

The coherency of light 800 is something that can be quantitatively measured and objectively described. A coherence metric 832 quantitatively describes the degree to which light 800 is at least partially coherent light 803.

Partial coherence can be measured in a variety of different ways. One way is to make a Michaelson interferometer. With non-coherent light one only gets fringes it the path lengths are perfectly equal (to within a wavelength of light). This is difficult to do. Any increase in fringe visibility beyond the equal-path condition is a measure of the “coherence length”. For lasers, this is measured in meters. For narrowband small LED sources this could be several microns.

Some embodiments may reduce coherence by as little as about 5% while other embodiments may reduce coherence by as much as about 35%. Many embodiments will fall into the range between 10%-50% reductions of coherence between the image 880 produced by the system 100 and the light generated by the light source 210.

Another way to measure coherence is to measure the standard deviation of the pixel values of an image of the light source 210. Since coherence does not depend on whether the source is in focus, using a defocused spot works quite well. The standard deviation is non-linearly proportional to the coherence length and the ratio of the standard deviation to the average pixel value is the “speckle contrast”. The speckle contrast in a dual diffuser 282 context can be half or even less than the speckle contrast for a single diffuser 282 in a similar configuration with a similar light source 210. The speckle contrast is known in the art.

b. Color Mix Metric

The mixing of different colors of light 800 is something that can be quantitatively measured and objectively described. A color mix metric 834 quantitatively describes the degree to which colors are mixed in a desirable fashion. The speckle contrast discussed above is also suitable as a color mix metric 834.

c. Optical Efficiency Metric

Light 800, like most resources, can be used to different degrees of efficiency. An optical efficiency metric 836 quantitatively describes the degree to which light is be used efficiently, i.e. not lost or wasted. Efficiency can be represented as a % of utilization, or conversely, as a % of waste.

The prior art affirmatively teaches away from the use of non-coherent light 804 in man-made display technologies. There are several reasons for this, including the heavy fixation of the prior art on optical efficiency.

Whether the topic is electronic displays such as television sets, movie projectors, computer monitors, or illumination devices more generally such as the lighting of interior and exterior spaces, optical efficiency is a constant and substantially overwhelming design consideration for any prior art illumination technology. Optical efficiency is obsequious in the marketing materials of illumination applications. No producer of illumination devices will advertise those products on the basis of optical inefficiency. As a result, no producer of illumination devices even considers the use of using less coherent light 800 with their display technologies.

Users 90 live in a real world that uses light inefficiently. Light is constantly bouncing of different objects at different angles and travelling different paths. Any effort to create more realistic light for an image 880 is going to involve the use of light 800 at lower level of efficiency than the conventional wisdom of the prior art. There is a direct relationship between coherency and efficiency in man-made display technologies.

B. Process-Flow View

The system 100 can be defined as collection of processes as well as a collection of assemblies. The system 100 is a collective configuration of components interacting with each other and performing various functions. The system 100 can also be characterized as a method for displaying one or more images 880 to one or more users 90. FIG. 1i is a flow chart diagram illustrating an example of method 900 for displaying an image 200 to a user 90 using light 800 that has been diffused two or more times.

At 912, a light source 210 is used to generate a pulse of light 800. As discussed above, that light 800 is partially coherent light 803 until it has been diffused by the diffusion subassembly 280.

At 914, the light 800 moves through a first diffuser 282.

At 916, the light 800 moves through a second diffuser 282.

At 920, an image 880 is created from the multiply diffused light 808.

As discussed above, a gap 290 can separate two diffusers 282. The cycle between the generating of light partially coherent light 803 by the light source 210 through the display of the image 880 repeats with “fresh” light for so long as an image 880 is being displayed.

C. Variations of Diffusers and Gaps

The system 100 can be implemented using a wide variety of different diffuser 282 and gap 290 configurations. Diffusers 282 can be described in terms of material composition as well as in terms of geometry and dimensions. An important aspect of a diffuser 282 is that it is comprised of a material that is somewhat transmissive of light 800 without being so permissively transmissive that the coherence of the light 800 is not impacted. Put another way, an effective diffuser 282 is at least somewhat translucent but not so substantially transparent that the coherence of the light 800 is not impacted. The use of diffusers 282 are known in the prior art, but the prior art affirmatively teaches away from the use of two or more diffusers 282 due to the resulting reduction in optical efficiency.

FIG. 1k is a hierarchy diagram illustrating an example of the different types of diffusers 282 that can be used. Examples of different types of diffusers 282 include but are not limited to a film diffuser 283, a paper diffuser 284, a glass diffuser 285, a coating diffuser 286, and virtually any multi-textured surface 287 that provides sufficient transmissivity.

Film diffusers 283 can also be referred to as plastic diffusers 282 because they are comprised of plastic film. Paper diffusers 284 are comprised of paper or paper-related material. Glass diffusers 285 are comprised a one of a variety of different types of glass. A coating diffuser 286 is a diffuser comprised of coating placed on an otherwise substantially transparent and transmissive object. Many multi-textured surfaces 287 can function as diffusers 282 if properly configured for the particular implementation.

The diffusers 282 can also be implemented in wide variety of shapes and sizes. Relatively flat and thin objects within the desired range of transparency can constitute desirable diffusers 282. Some diffusers 282 can be curved, while others may be straight. Some diffusers 282 may have uniform thickness while other diffusers 282 may be shaped in a concave or convex manner. The scale/dimensions of the diffuser 282 will depend on the scale/dimensions of the light source 210 and the scale of the image 880 displayed by the system 100. Many types of materials are potentially functional diffusers 282 if they are thin enough. For example, an ordinary sheet of paper can be semi-transparent when you hold it up to the light at the proper angle.

The system 100 can utilize a variety of different gaps 290. Gaps can vary in terms of length (i.e. distance from one diffuser 282 to another diffuser 282) as well as in terms of composition. A gap 290 can be empty space or it can be comprised of a substantially transparent object, such as glass. FIG. 1l is a hierarchy diagram illustrating an example of different types of gaps 290. The two most common categories of gaps 290 are air gaps 291 comprising empty space and glass gaps 292 comprising a substantially transparent substance such as glass. Gaps 290 can be an important part of the diffusion process and the diffusion subassembly 280.

The system 100 can be implemented using a glass plate coated on two sides with a diffuser coating 286. Each surface coating 286 would function as a diffuser 282 and the glass plate between the two coatings would constitute the gap 290 between the two diffusers 282. Other embodiments may involve mere empty space between the diffusers 282. The composition and distance of the gap 290 can vary widely between the different embodiments of the system 100. In some embodiments, a gap 290 of less than about 1 mm is sufficient. In other embodiments, a far larger gap 290 such as a gap 290 spanning multiple centimeters can be used. It is believed that a gap between 1 mm and 8 mm will be sufficient for many embodiments of the system 100.

This functionality is affirmatively taught away by the prior art because it reduces optical efficiency. Almost all illumination structures in the prior art attempt to maximize optical efficiency while so they almost always only use a single “mixing element” such as a single diffuser film or fly's eye display. This double diffuser technique can reduce optical efficiency by approximately 30% but forms more natural light.

This works particularly well for near-eye displays that use reflection (LCOS or DMD) light modulators.

The apparatus with the multiple-diffuser option can be made by using two (or more) diffusive films that are spaced ˜8 mm apart in the illumination path of our near eye display. They are located between the source LED (which is RGB) and the collimation optics which are used to shape the light. These films take the coherent colored light from the LEDs and break up the coherence and thoroughly mix the light for natural illumination.

The test results show a much more comfortable image is achieved with better color uniformity while using multiple diffusers. This was tested in the same near-eye display system and was compared to the use of a single film and no film at all. A third and fourth film were also added and tested, but the real performance benefits were achieved when a second film was added with space between it and the first film.

### II. Assemblies and Components

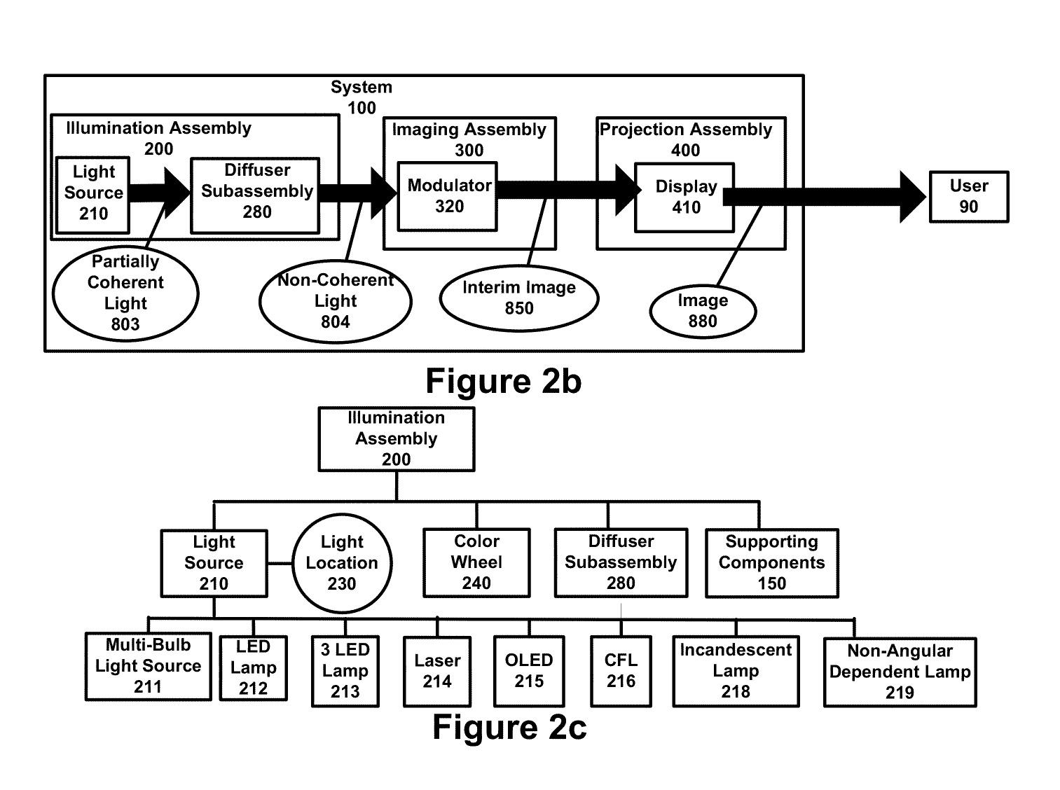

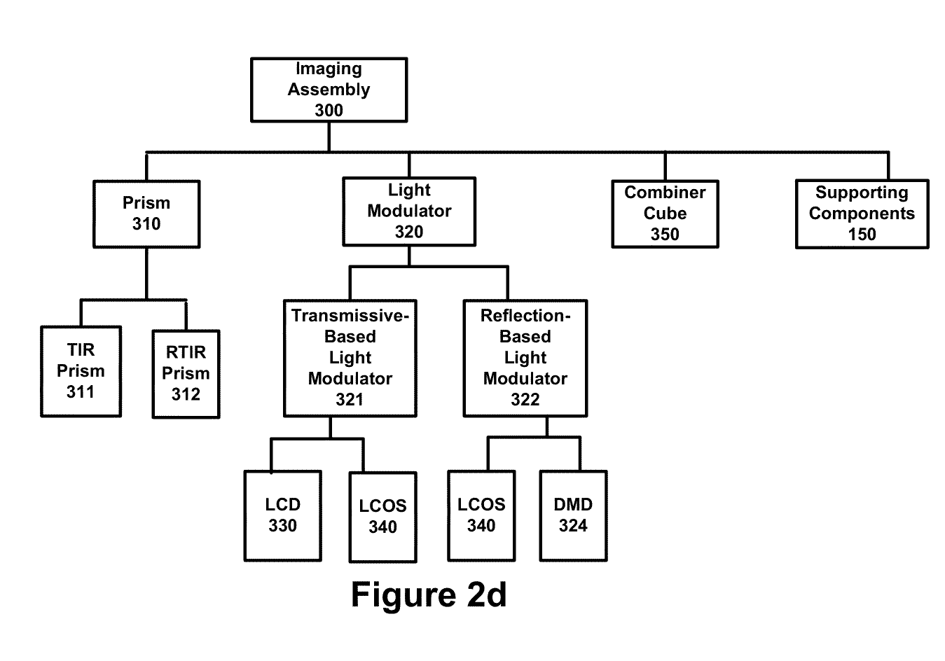

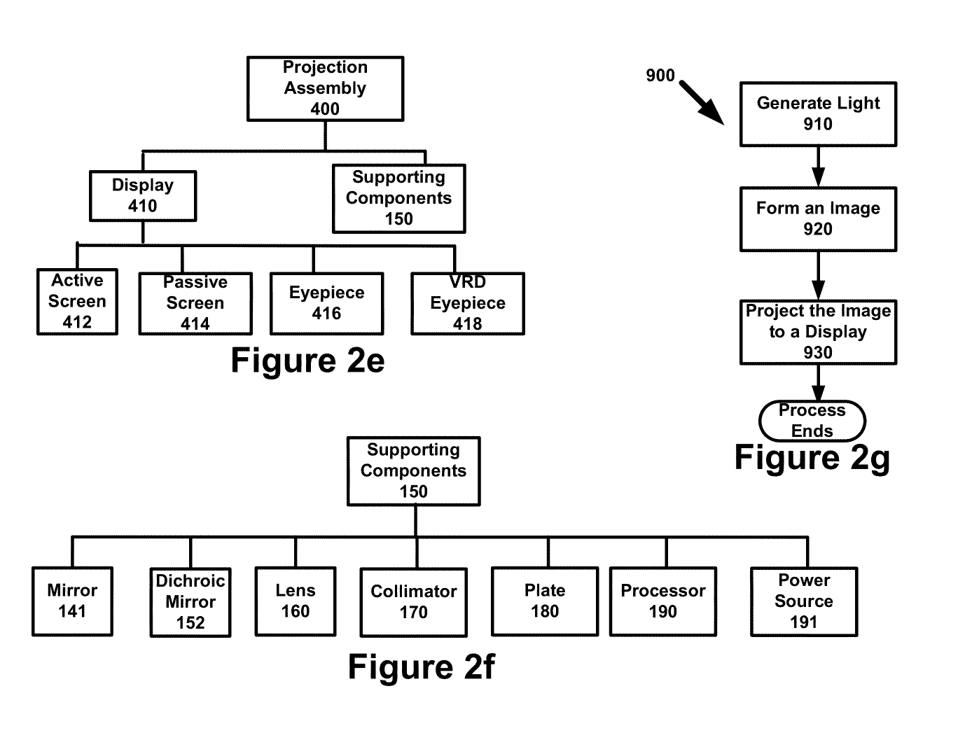

The system 100 can be described in terms of assemblies of components that perform various functions in support of the operation of the system 100. FIG. 2a is a block diagram of a system 100 comprised of an illumination assembly 200 that supplies light 800 (non-coherent light 804 to be more specific) to the imaging assembly 300. The imaging assembly 300 uses the light 800 from the illumination assembly 200 to create the image 880 that is displayed by the system 100. As illustrated in FIG. 2b, the system 100 can also include a projection assembly 400 that directs the image 880 from the imaging assembly 300 to a location where it can be accessed by one or more users 90. The image 880 generated by the imaging assembly 300 will often be modified in certain ways before it is displayed by the system 100 to users 90, and thus the image generated by the imaging assembly 300 can also be referred to as an interim image 850 or a work-in-process image 850.

A. Illumination Assembly

An illumination assembly 200 performs the function of supplying light 800 to the system 100 so that an image 880 can be displayed. As illustrated in FIGS. 2a and 2b, the illumination assembly 200 can include a light source 210 for generating light 800 and a diffuser assembly 280 for diffusing that light 800. The light source 210 generates partially coherent light 803, but the diffuser subassembly 280 of two or more diffusers 282 and one or more gaps 290 transforms the partially coherent light 803 of the light source 210 into non-coherent light 804 that can be used by the imaging assembly 300 to create the image 880.

FIG. 2c is a hierarchy diagram illustrating an example of different components that can be included in the illumination assembly 200. Those components can include but are not limited a wide range of light sources 210, a color wheel 240 or other type of colorizing filter, a diffuser assembly 280, and a variety of supporting components 150. Examples of light sources 210 can include but are such as a multi-bulb light source 211, an LED lamp 212, a 3 LED lamp 213, a laser 214, an OLED 215, a CFL 216, an incandescent lamp 218, and a non-angular dependent lamp 219. The light source 210 is where light 800 is generated and moves throughout the rest of the system 100. Thus, each light source 210 is a location 230 for the origination of light 800.

B. Imaging Assembly

An imaging assembly 300 performs the function of creating the image 880 from the light 800 supplied by the illumination assembly 200. As illustrated in FIG. 2a, a modulator 320 can transform the light 800 supplied by the illumination assembly 200 into the image 880 that is displayed by the system 100. As illustrated in FIG. 2b, the image 880 generated by the imaging assembly 300 can sometimes be referred to as an interim image 850 because the image 850 may be focused or otherwise modified to some degree before it is directed to the location where it can be experienced by one or more users 90.

Imaging assemblies 300 can vary significantly based on the type of technology used to create the image. Display technologies such as DLP (digital light processing), LCD (liquid-crystal display), LCOS (liquid crystal on silicon), and other methodologies can involve substantially different components in the imaging assembly 300. Nonetheless, such a diversity of imaging components can benefit from the diffuser subassembly 280 comprised of two or more diffusers 282 and one or more gaps 290.

FIG. 2d is a hierarchy diagram illustrating an example of different components that can be utilized in the imaging assembly 300 for the system 100. A prism 310 can be very useful component in directing light to and/or from the modulator 320. DLP applications will typically use an array of TIR prisms 311 or RTIR prisms 312 to direct light to and from a DMD 324.

A light modulator 320 is the device that modifies or alters the light 800, creating the image 880 that is to be displayed. Modulators 320 can operate using a variety of different attributes of the modulator 320. A reflection-based modulator 322 uses the reflective-attributes of the modulator 320 to fashion an image 880 from the supplied light 800. Examples of reflection-based modulators 322 include but are not limited to the DMD 324 of a DLP display and some LCOS (liquid crystal on silicon) panels 340. A transmissive-based modulator 321 uses the transmissive-attributes of the modulator 320 to fashion an image 880 from the supplied light 800. Examples of transmissive-based modulators 321 include but are not limited to the LCD (liquid crystal display) 330 of an LCD display and some LCOS panels 340. The imaging assembly 300 for an LCOS or LCD system 100 will typically have a combiner cube 350 or some similar device for integrating the different one-color images into a single image 880.

The imaging assembly 300 can also include a wide variety of supporting components 150.

C. Projection Assembly

As illustrated in FIG. 2b, a projection assembly 400 can perform the task of directing the image 880 to its final destination in the system 100 where it can be accessed by users 90. In many instances, the image 880 created by the imaging assembly 300 will be modified in at least some minor ways between the creation of the image 880 by the modulator 320 and the display of the image 880 to the user 90. Thus, the image 880 generated by the modulator 320 of the imaging assembly 400 may only be an interim image 850, not the final version of the image 880 that is actually displayed to the user 90.

FIG. 2e is a hierarchy diagram illustrating an example of different components that can be part of the projection assembly 400. A display 410 is the final destination of the image 880, i.e. the location and form of the image 880 where it can be accessed by users 90. Examples of displays 410 can include an active screen 412, a passive screen 414, an eyepiece 416, and a VRD eyepiece 418.

The projection assembly 400 can also include a variety of supporting components 150 as discussed below.

D. Supporting Components

Light 800 can be a challenging resource to manage. Light 800 moves quickly and cannot be constrained in the same way that most inputs or raw materials can be. FIG. 2f is a hierarchy diagram illustrating an example of some supporting components 150, many of which are conventional optical components. Any display technology application will involve conventional optical components such as mirrors 141 (including dichroic mirrors 152) lenses 160, collimators 170, and plates 180. Similarly, any powered device requires a power source 191 and a device capable of displaying an image 880 is likely to have a processor 190.

E. Process Flow View

The system 100 can be described as the interconnected functionality of an illumination assembly 200, an imaging assembly 300, and a projection assembly 400. The system 100 can also be described in terms of a method 900 that includes an illumination process 910, an imaging process 920, and a projection process 930.

### III. Different Display Technologies

The system 100 can be implemented with respect to a wide variety of different display technologies, including but not limited to DLP, LCD, and LCOS.

A. DLP Embodiments

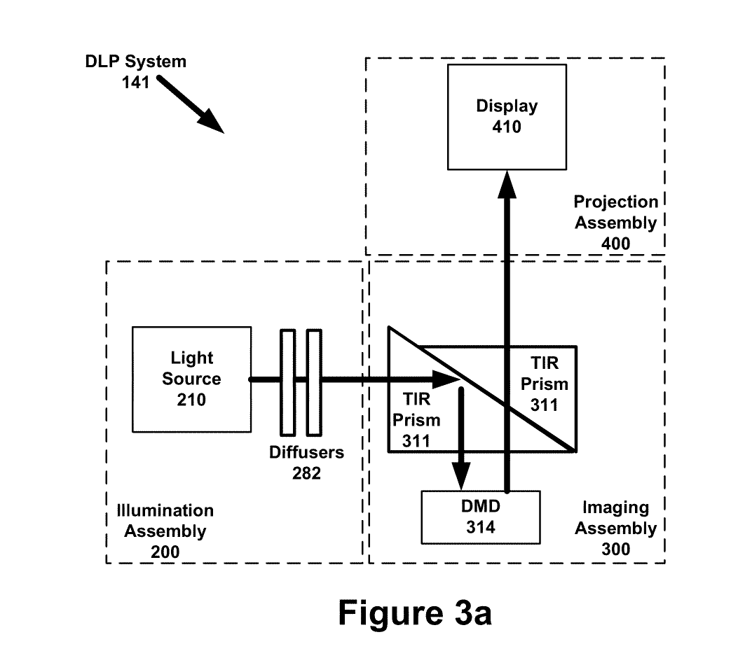

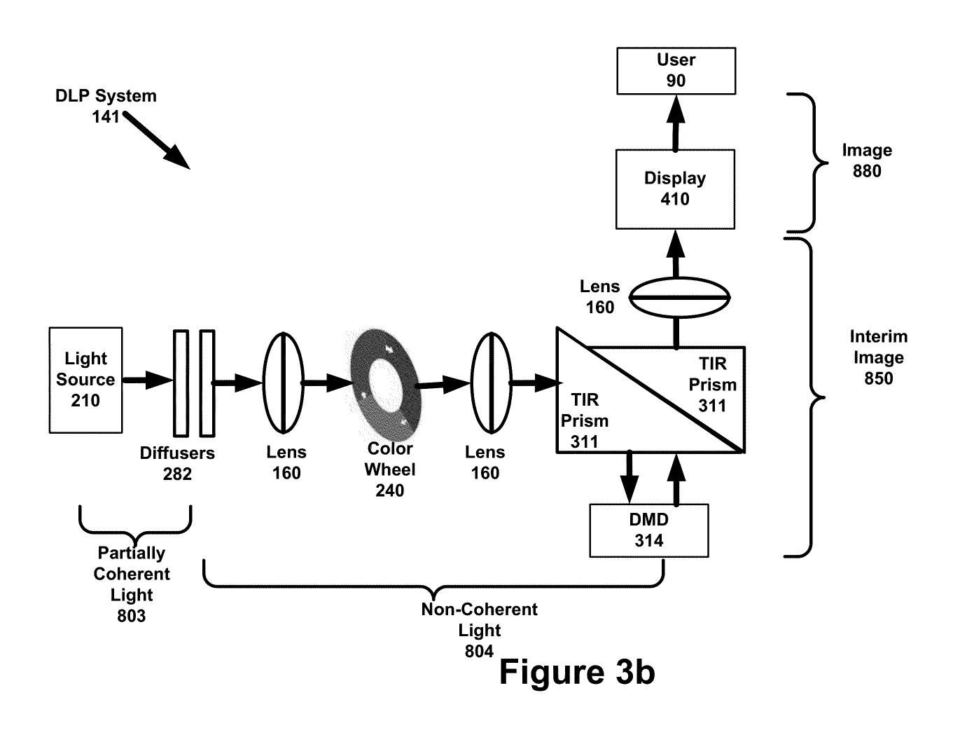

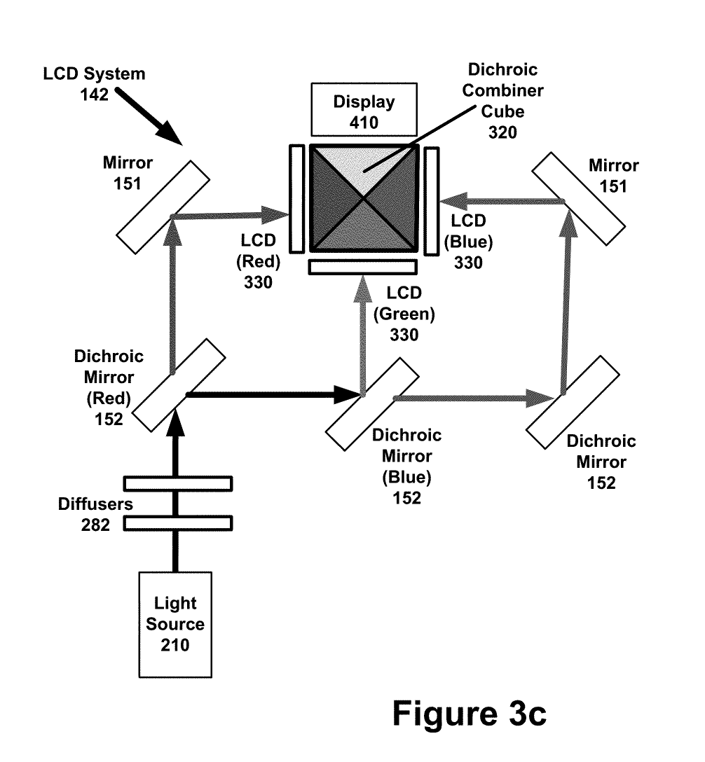

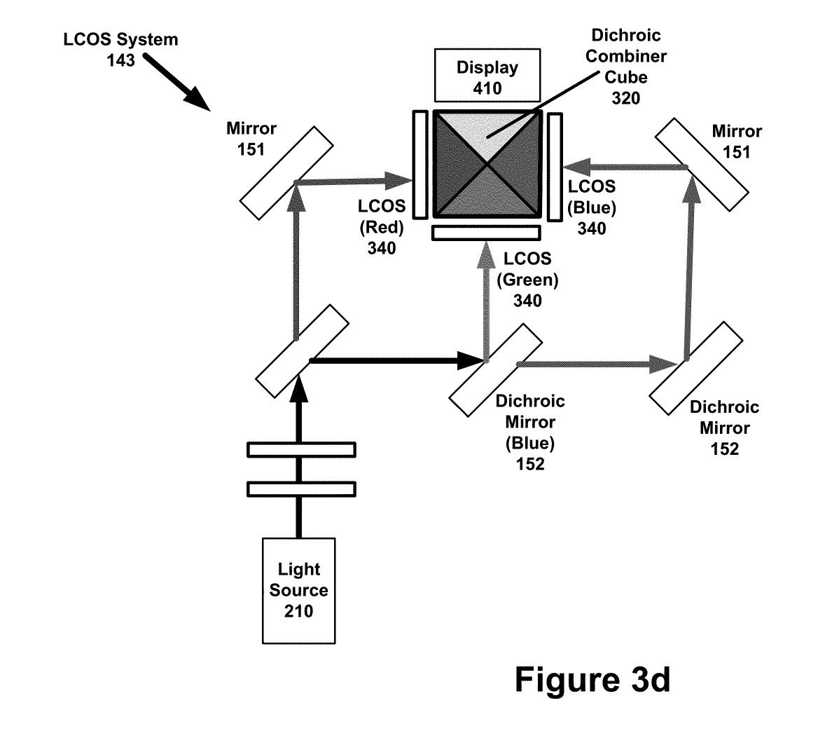

FIG. 3a illustrates an example of a DLP system 141, i.e. an embodiment of the system 100 that utilizes DLP optical elements. DLP systems 141 utilize a DMD 314 (digital micromirror device) comprised of millions of tiny mirrors as the modulator 320. Each micro mirror in the DMD 314 can pertain to a particular pixel in the image 880.

As discussed above, the illumination assembly 200 includes a light source 210 and multiple diffusers 282. The light 800 then passes to the imaging assembly 300. Two TIR prisms 311 direct the light 800 to the DMD 314, the DMD 314 creates an image 880 with that light 800, and the TIR prisms 311 then direct the light 800 embodying the image 880 to the display 410 where it can be enjoyed by one or more users 90.

FIG. 3b is a more detailed example of a DLP system 141. The illumination assembly 200 includes a color wheel 240 or other similar filter between two lenses 160, typically a condensing lens 160 is used before the color wheel 240, and a shaping lens 160 is used to direct the light 800 to the array of TIR prisms 311. A lens 150 is positioned before the display 410 to modify/focus image 880 before providing the image 880 to the users 90. FIG. 3b also includes a more specific term for the light 800 at various stages in the process. Light 800 is partially coherent light 803 until it reaches the two diffusers 282, after which it is non-coherent light 804. The non-coherent light 804 leaving the DMD 314 is an interim image 850 which becomes the final image 880 by the time it reaches the display 410.

B. LCD Embodiments

FIG. 3c is a diagram illustrating an example of an LCD system 142. LCD stands for liquid crystal display. The modulator 320 in an LCD system 142 is one or more LCD panels 330 comprised of liquid crystals which are electronically manipulated to form the image 880.

The illumination assembly 200 in an LCD system 142 typically include a variety of dichroic mirrors 152 that separate light 800 into three component colors, typically red, green, and blue—the same colors on many color wheels 240 found in a DLP application.

The LCDs 330 form single color images which are combined into a multi-color image 880 by a dichroic combiner cube 320 or some similar device.

C. LCOS Embodiments

FIG. 3d is a diagram illustrating an example of an LCOS system 143. LCOS is a hybrid between DLP and LCD. LCOS stands for liquid crystal on silicon displays. The LCOS panel 340 is an LCD panel 330 that includes a computer chip analogous to the chip found in a DMD 314 of a DLP application.

### IV. VRD Visor Embodiments

The system 100 can be implemented in a wide variety of different configurations and scales of operation. However, the original inspiration for the conception of the multiple diffuser concept occurred in the context of a VRD visor system 106 embodied as a VRD visor apparatus 116. A VRD visor apparatus 116 projects the image 880 directly onto the eyes of the user 90. The VRD visor apparatus 116 is a device that can be worn on the head of the user 90. In many embodiments, the VRD visor apparatus 116 can include sound as well as visual capabilities. Such embodiments can include multiple modes of operation, such as visual only, audio only, and audio-visual modes. When used in a non-visual mode, the VRD apparatus 116 can be configured to look like ordinary headphones.

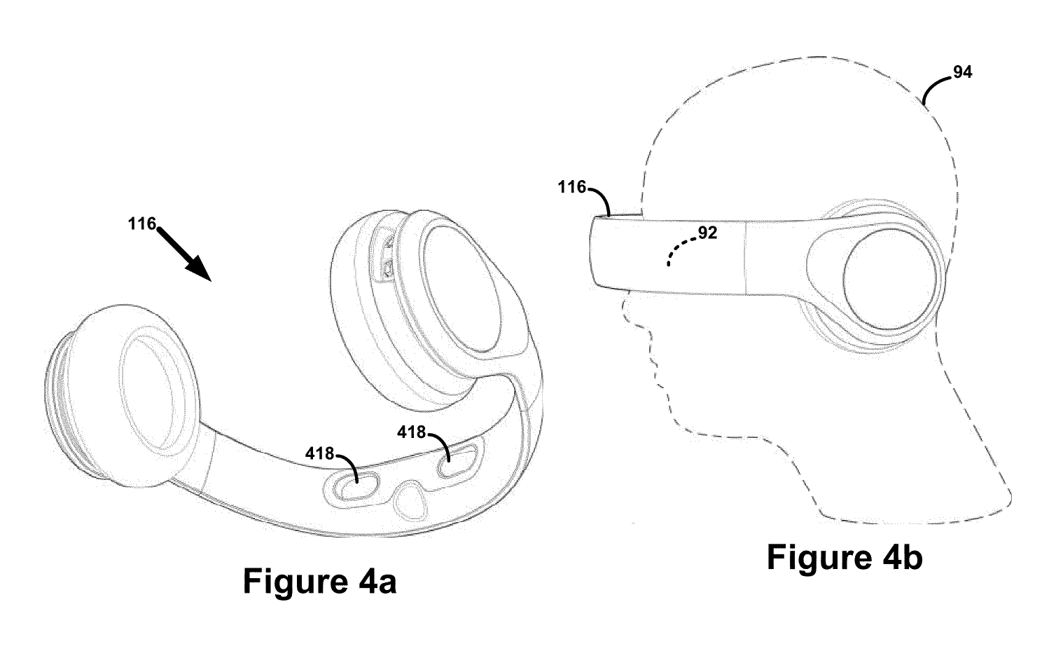

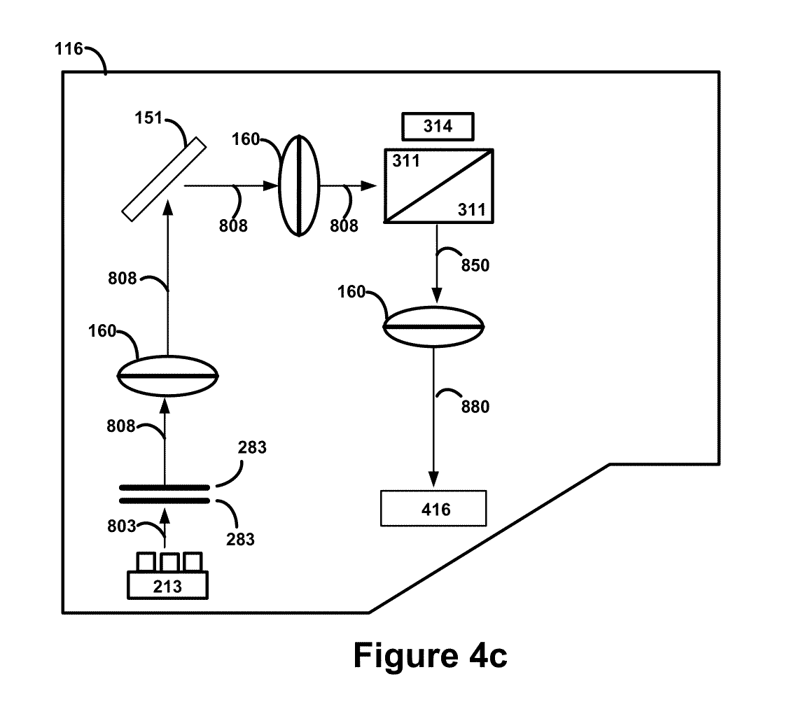

FIG. 4a is a perspective diagram illustrating an example of a VRD visor apparatus 116. Two VRD eyepieces 418 provide for directly projecting the image 880 onto the eyes of the user 90.

FIG. 4b is a side view diagram illustrating an example of a VRD visor apparatus 116 being worn on the head 94 of a user 90. The eyes 92 of the user 90 are blocked by the apparatus 116 itself, with the apparatus 116 in a position to project the image 880 on the eyes 92 of the user 90.

FIG. 4c is a component diagram illustrating an example of a VRD visor apparatus 116 for the left eye 92. A mirror image of FIG. 4c would pertain to the right eye 92.

A 3 LED light source 213 generates partially coherent light 803 that passes through two film diffusers 283. A condensing lens 160 directs the non-coherent light 808 to a mirror 151 which reflects the non-coherent light 808 to a shaping lens 160 prior to the entry of the light 800 into an imaging assembly 300 comprised of two TIR prisms 311 and a DMD 314. The interim image 850 from the imaging assembly 300 passes through another lens 160 that focuses the interim image 850 into a final image 880 that is viewable to the user 90 through the eyepiece 416.

### V. Alternative Embodiments

No patent application can expressly disclose in words or in drawings, all of the potential embodiments of an invention. Variations of known equivalents are implicitly included. In accordance with the provisions of the patent statutes, the principles, functions, and modes of operation of the systems 100, methods 900, and apparatuses 110 (collectively the “system” 100) are explained and illustrated in certain preferred embodiments. However, it must be understood that the inventive systems 100 may be practiced otherwise than is specifically explained and illustrated without departing from its spirit or scope.

The description of the system 100 provided above and below should be understood to include all novel and non-obvious alternative combinations of the elements described herein, and claims may be presented in this or a later application to any novel non-obvious combination of these elements. Moreover, the foregoing embodiments are illustrative, and no single feature or element is essential to all possible combinations that may be claimed in this or a later application.

The system 100 represents a substantial improvement over prior art display technologies. Just as there are a wide range of prior art display technologies, the system 100 can be similarly implemented in a wide range of different ways. The innovation of utilizing two diffusers 282 separated by a gap 290 can be implemented at a variety of different scales, utilizing a variety of different display technologies, in both immersive and augmenting contexts, and in both one-way (no sensor feedback from the user 90) and two-way (sensor feedback from the user 90) embodiments.

A. Variations of Scale

Display devices can be implemented in a wide variety of different scales. The monster scoreboard at EverBanks Field (home of the Jacksonville Jaguars) is a display system that is 60 feet high, 362 feet long, and comprised of 35.5 million LED bulbs. The scoreboard is intended to be viewed simultaneously by tens of thousands of people. At the other end of the spectrum, the GLYPH™ visor by Avegant Corporation is a device that is worn on the head of a user and projects visual images directly in the eyes of a single viewer. Between those edges of the continuum are a wide variety of different display systems.

The system 100 displays visual images 808 to users 90 with enhanced light with reduced coherence. The system 100 can be potentially implemented in a wide variety of different scales.

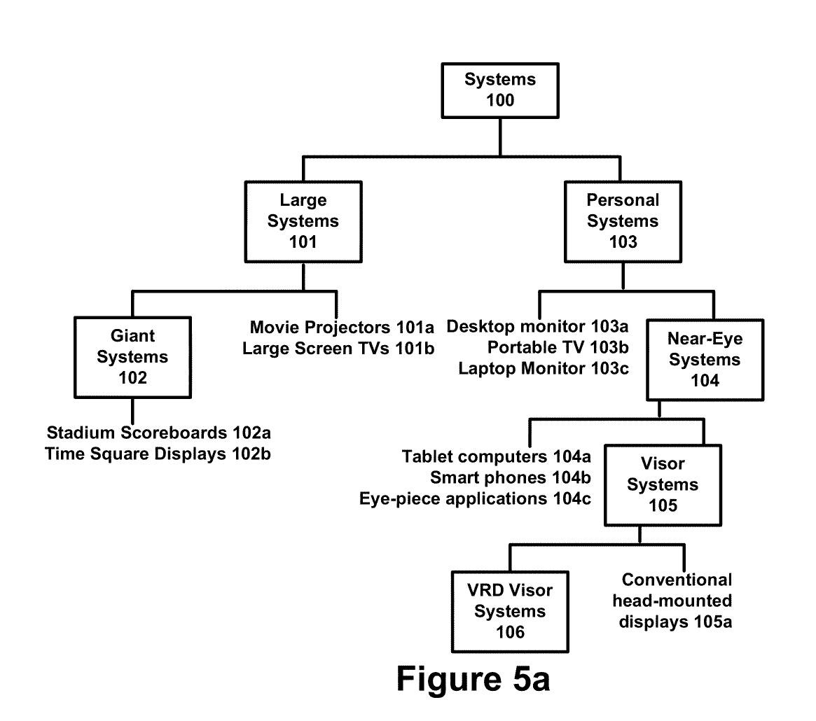

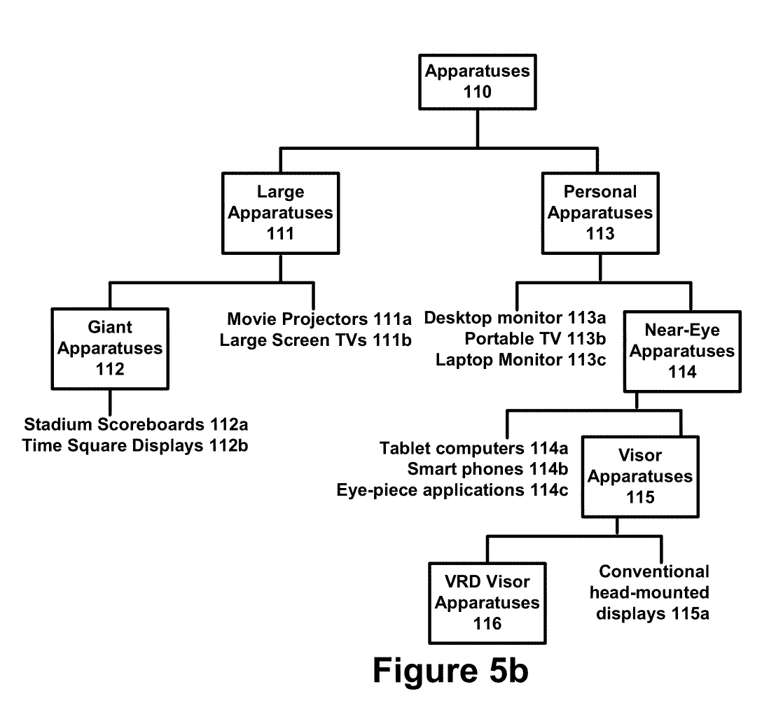

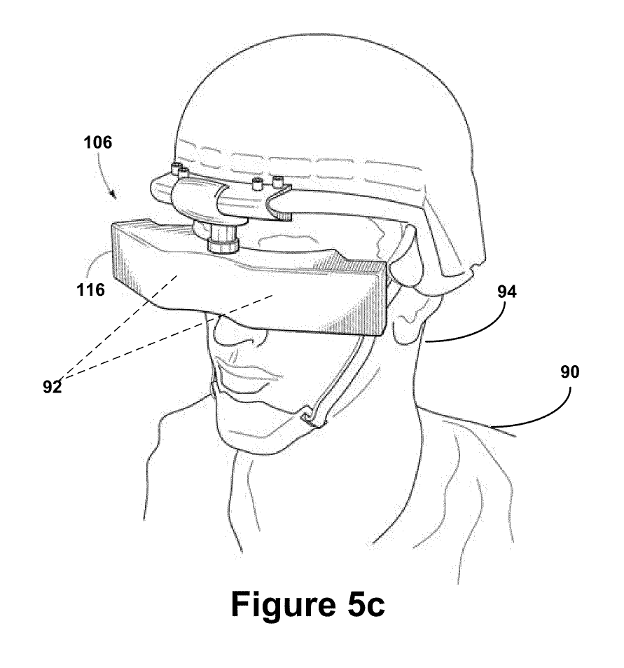

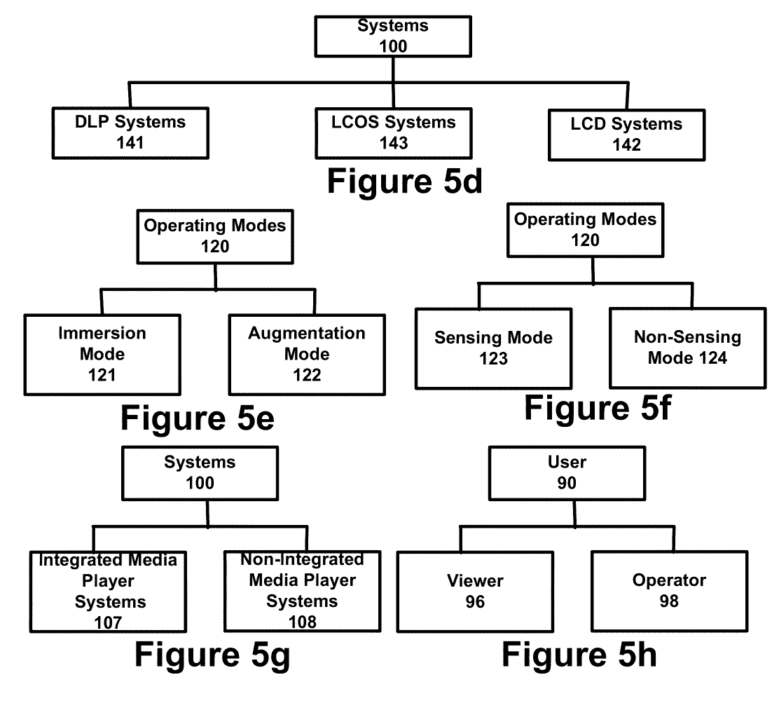

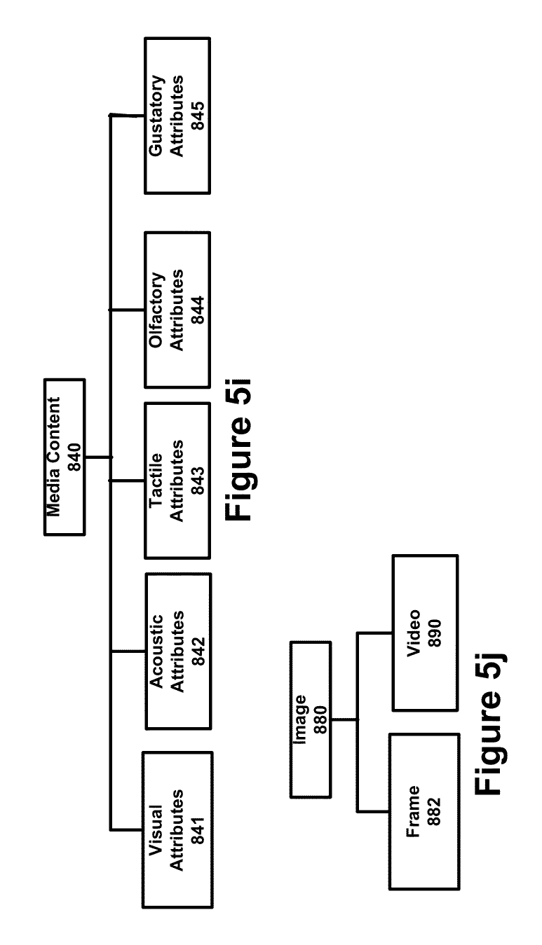

FIG. 5a is a hierarchy diagram illustrating various categories and subcategories pertaining to the scale of implementation for display systems generally, and the system 100 specifically. As illustrated in FIG. 2a, the system 100 can be implemented as a large system 101 or a personal system 103

1. Large Systems

A large system 101 is intended for use by more than one simultaneous user 90. Examples of large systems 101 include movie theater projectors, large screen TVs in a bar, restaurant, or household, and other similar displays. Large systems 101 include a subcategory of giant systems 102, such as stadium scoreboards 102a, the Time Square displays 102b, or other or the large outdoor displays such as billboards off the expressway.

2. Personal Systems

A personal system 103 is an embodiment of the system 100 that is designed to for viewing by a single user 90. Examples of personal systems 103 include desktop monitors 103a, portable TVs 103b, laptop monitors 103c, and other similar devices. The category of personal systems 103 also includes the subcategory of near-eye systems 104.

a. Near-Eye Systems

A near-eye system 104 is a subcategory of personal systems 103 where the eyes of the user 90 are within about 12 inches of the display. Near-eye systems 104 include tablet computers 104a, smart phones 104b, and eye-piece applications 104c such as cameras, microscopes, and other similar devices. The subcategory of near-eye systems 104 includes a subcategory of visor systems 105.

b. Visor Systems

A visor system 105 is a subcategory of near-eye systems 104 where the portion of the system 100 that displays the visual image 200 is actually worn on the head 94 of the user 90. Examples of such systems 105 include virtual reality visors, Google Glass, and other conventional head-mounted displays 105a. The category of visor systems 105 includes the subcategory of VRD visor systems 106.

c. VRD Visor Systems

A VRD visor system 106 is an implementation of a visor system 105 where visual images 200 are projected directly on the eyes of the user. The technology of projecting images directly on the eyes of the viewer is disclosed in a published patent application titled “IMAGE GENERATION SYSTEMS AND IMAGE GENERATING METHODS” (U.S. Ser. No. 13/367,261) that was filed on Feb. 6, 2012, the contents of which are hereby incorporated by reference. It is anticipated that a VRD visor system 106 is particularly well suited for the implementation of the multiple diffuser 140 approach for reducing the coherence of light 210.

3. Integrated Apparatus

Media components tend to become compartmentalized and commoditized over time. It is possible to envision display devices where an illumination assembly 120 is only temporarily connected to a particular imaging assembly 160. However, in most embodiments, the illumination assembly 120 and the imaging assembly 160 of the system 100 will be permanently (at least from the practical standpoint of users 90) into a single integrated apparatus 110. FIG. 5b is a hierarchy diagram illustrating an example of different categories and subcategories of apparatuses 110. FIG. 5b closely mirrors FIG. 5a. The universe of potential apparatuses 110 includes the categories of large apparatuses 111 and personal apparatuses 113. Large apparatuses 111 include the subcategory of giant apparatuses 112. The category of personal apparatuses 113 includes the subcategory of near-eye apparatuses 114 which includes the subcategory of visor apparatuses 115. VRD visor apparatuses 116 comprise a category of visor apparatuses 115 that implement virtual retinal displays, i.e. they project visual images 200 directly into the eyes of the user 90.

FIG. 5c is a diagram illustrating an example of a perspective view of a VRD visor system 106 embodied in the form of an integrated VRD visor apparatus 116 that is worn on the head 94 of the user 90. Dotted lines are used with respect to element 92 because the eyes 92 of the user 90 are blocked by the apparatus 116 itself in the illustration.

B. Different Categories of Display Technology

The prior art includes a variety of different display technologies, including but not limited to DLP (digital light processing), LCD (liquid crystal displays), and LCOS (liquid crystal on silicon). FIG. 5d, which is a hierarchy diagram illustrating different categories of the system 100 based on the underlying display technology in which the two (or more) diffusers 282 separated by a gap 290 can be implemented. As illustrated in FIG. 5d, the system 100 can be implemented as a DLP system 141, an LCOS system 143, and an LCD system 142. The system 100 can also be implemented in other categories and subcategories of display technologies.

C. Immersion Vs. Augmentation

FIG. 5e is a hierarchy diagram illustrating a hierarchy of systems 100 organized into categories based on the distinction between immersion and augmentation. Some embodiments of the system 100 can have a variety of different operating modes 120. An immersion mode 121 has the function of blocking out the outside world so that the user 90 is focused exclusively on what the system 100 displays to the user 90. In contrast, an augmentation mode 122 is intended to display visual images 200 that are superimposed over the physical environment of the user 90. The distinction between immersion and augmentation modes of the system 100 is particularly relevant in the context of near-eye systems 104 and visor systems 105.

Some embodiments of the system 100 can be configured to operate either in immersion mode or augmentation mode, at the discretion of the user 90. While other embodiments of the system 100 may possess only a single operating mode 120.

D. Display Only Vs. Display/Detect/Track/Monitor

Some embodiments of the system 100 will be configured only for a one-way transmission of optical information. Other embodiments can provide for capturing information from the user 90 as visual images 880 and potentially other aspects of a media experience are made accessible to the user 90. FIG. 5f is a hierarchy diagram that reflects the categories of a one-way system 124 (a non-sensing operating mode 124) and a two-way system 123 (a sensing operating mode 123). A two-way system 123 can include functionality such as retina scanning and monitoring. Users 90 can be identified, the focal point of the eyes 92 of the user 90 can potentially be tracked, and other similar functionality can be provided. In a one-way system 124, there is no sensor or array of sensors capturing information about or from the user 90.

E. Media Players—Integrated Vs. Separate

Display devices are sometimes integrated with a media player. In other instances, a media player is totally separate from the display device. By way of example, a laptop computer can include in a single integrated device, a screen for displaying a movie, speakers for projecting the sound that accompanies the video images, a DVD or BLU-RAY player for playing the source media off a disk. Such a device is also capable of streaming

FIG. 5g is a hierarchy diagram illustrating a variety of different categories of systems 100 based on the whether the system 100 is integrated with a media player or not. An integrated media player system 107 includes the capability of actually playing media content as well as displaying the image 880. A non-integrated media player system 108 must communicate with a media player in order to play media content.

F. Users—Viewers Vs. Operators

FIG. 5h is a hierarchy diagram illustrating an example of different roles that a user 90 can have. A viewer 96 can access the image 880 but is not otherwise able to control the functionality of the system 100. An operator 98 can control the operations of the system 100, but cannot access the image 880. In a movie theater, the viewers 96 are the patrons and the operator 98 is the employee of the theater.

G. Attributes of Media Content

As illustrated in FIG. 5i, media content 840 can include a wide variety of different types of attributes. A system 100 for displaying an image 880 is a system 100 that plays media content 840 with a visual attribute 841. However, many instances of media content 840 will also include an acoustic attribute 842 or even a tactile attribute. Some new technologies exist for the communication of olfactory attributes 844 and it is only a matter of time before the ability to transmit gustatory attributes 845 also become part of a media experience in certain contexts.

As illustrated in FIG. 5j, some images 880 are parts of a larger video 890 context. In other contexts, an image 880 can be stand-alone still frame 882.

### VI. Glossary/Definitions

| # | Name | Definition/Description |
|---|---|---|
| 90 | User | A user 90 is a viewer 96 and/or operator 98 of the system 100. The |
| | | user 90 is typically a human being. In alternative embodiments, users |
| | | 90 can be different organisms such as dogs or cats, or even automated |
| | | technologies such as expert systems, artificial intelligence |
| | | applications, and other similar “entities”. |
| 92 | Eye | An organ of the user 90 that provides for the sense of sight. The eye |
| | | consists of different portions including but not limited to the sclera, iris, |
| | | cornea, pupil, and retina. Some embodiments of the system 100 |
| | | involve a VRD visor apparatus 126 that can project the desired image |
| | | 880 directly onto the eye 92 of the user 90. |
| 94 | Head | The portion of the body of the user 90 that includes the eye 92. Some |
| | | embodiments of the system 100 can involve a visor apparatus 115 that |
| | | is worn on the head 94 of the user 90. |
| 96 | Viewer | A user 90 of the system 100 who views the image 880 provided by the |
| | | system 100. All viewers 96 are users 90 but not all users 90 are |
| | | viewers 96. The viewer 96 does not necessarily control or operate the |
| | | system 100. The viewer 96 can be a passive beneficiary of the system |
| | | 100, such as a patron at a movie theater who is not responsible for the |
| | | operation of the projector or someone wearing a visor apparatus 115 |
| | | that is controlled by someone else. |
| 98 | Operator | A user 90 of the system 100 who exerts control over the processing of |
| | | the system 100. All operators 98 are users 90 but not all users 90 are |
| | | operators 98. The operator 98 does not necessarily view the images |
| | | 880 displayed by the system 100 because the operator 98 may be |
| | | someone operating the system 100 for the benefit of others who are |
| | | viewers 96. For example, the operator 98 of the system 100 may be |
| | | someone such as a projectionist at a movie theater or the individual |
| | | controlling the system 100. |
| 100 | System | A collective configuration of assemblies, subassemblies, components, |
| | | processes, and/or data that provide a user 90 with the functionality of |
| | | engaging in a media experience such as viewing an image 890. Some |
| | | embodiments of the system 100 can involve a single integrated |
| | | apparatus 110 hosting all components of the system 100 while other |
| | | embodiments of the system 100 can involve different non-integrated |
| | | device configurations. Some embodiments of the system 100 can be |
| | | large systems 102 or even giant system 101 while other embodiments |
| | | of the system 100 can be personal systems 103, such as near-eye |
| | | systems 104, visor systems 105, and VRD visor systems 106. |
| | | Systems 100 can also be referred to as media systems 100 or display |
| | | systems 100. |
| 101 | Giant System | An embodiment of the system 100 intended to be viewed |
| | | simultaneously by a thousand or more people. Examples of giant |
| | | systems 101 include scoreboards at large stadiums, electronic |
| | | billboards such the displays in Time Square in New York City, and |
| | | other similar displays. A giant system 100 is a subcategory of large |
| | | systems 102. |
| 102 | Large System | An embodiment of the system 100 that is intended to display an image |
| | | 880 to multiple users 90 at the same time. A large system 102 is not |
| | | a personal system 103. The media experience provided by a large |
| | | system 102 is intended to be shared by a roomful of viewers 96 using |
| | | the same illumination assembly 200, imaging assembly 300, and |
| | | projection assembly 400. Examples of large systems 102 include but |
| | | are not limited to a projector/screen configuration in a movie theater, |
| | | classroom, or conference room; television sets in sports bar, airport, |
| | | or residence; and Scoreboard displays at a stadium. Large systems |
| | | 101 can also be referred to as large media systems 101. |
| 103 | Personal | A category of embodiments of the system 100 where the media |
| | System | experience is personal to an individual viewer 96. Common examples |
| | | of personal media systems include desktop computers (often referred |
| | | to as personal computers), laptop computers, portable televisions, and |
| | | near-eye systems 104. Personal systems 103 can also be referred to |
| | | as personal media systems 103. Near-eye systems 104 are a |
| | | subcategory of personal systems 103. |
| 104 | Near-Eye | A category of personal systems 103 where the media experience is |
| | System | communicated to the viewer 96 at a distance that is less than or equal |
| | | to about 12 inches (30.48 cm) away. Examples of near-eye systems |
| | | 103 include but are not limited to tablet computers, smart phones, and |
| | | visor media systems 105. Near-eye systems 104 can also be referred |
| | | to as near-eye media systems 104. Near-eye systems 104 include |
| | | devices with eye pieces such as cameras, telescopes, microscopes, etc. |
| 105 | Visor System | A category of near-eye media systems 104 where the device or at |
| | | least one component of the device is worn on the head 94 of the viewer |
| | | 96 and the image 880 is displayed in close proximity to the eye 92 of |
| | | the user 90. Visor systems 105 can also be referred to as visor media |
| | | systems 105. |
| 106 | VRD Visor | VRD stands for a virtual retinal display. VRDs can also be referred to |
| | System | as retinal scan displays (“RSD”) and as retinal projectors (“RP”). VRD |
| | | projects the image 880 directly onto the retina of the eye 92 of the |
| | | viewer 96. A VRD Visor System 106 is a visor system 105 that utilizes |
| | | a VRD to display the image 880 on the eyes 92 of the user 90. A VRD |
| | | visor system 106 can also be referred to as a VRD visor media system 106. |
| 110 | Apparatus | An at least substantially integrated device that provides the |
| | | functionality of the system 100. The apparatus 110 can include the |
| | | illumination assembly 200, the imaging assembly 300, and the |
| | | projection assembly 400. Some embodiments of the apparatus 110 |
| | | can include a media player 848 while other embodiments of the |
| | | apparatus 110 are configured to connect and communicate with an |
| | | external media player 848. Different configurations and connection |
| | | technologies can provide varying degrees of “plug and play” |
| | | connectivity that can be easily installed and removed by users 90. |
| 111 | Giant | An apparatus 111 implementing an embodiment of a giant system |
| | Apparatus | 101. Common examples of a giant apparatus 111 include the |
| | | scoreboards at a professional sports stadium or arena. |
| 112 | Large | An apparatus 110 implementing an embodiment of a large system |
| | Apparatus | 102. Common examples of large apparatuses 111 include movie |
| | | theater projectors and large screen television sets. A large apparatus |
| | | 111 is typically positioned on a floor or some other support structure. |
| | | A large apparatus 111 such as a flat screen TV can also be mounted |
| | | on a wall. |
| 113 | Personal Media | An apparatus 110 implementing an embodiment of a personal system |
| | Apparatus | 103. Many personal apparatuses 112 are highly portable and are |
| | | supported by the user 90. Other embodiments of personal media |
| | | apparatuses 112 are positioned on a desk, table, or similar surface. |
| | | Common examples of personal apparatuses 112 include desktop |
| | | computers, laptop computers, and portable televisions. |
| 114 | Near-Eye | An apparatus 110 implementing an embodiment of a near-eye system |
| | Apparatus | 104. Many near-eye apparatuses 114 are either worn on the head |
| | | (are visor apparatuses 115) or are held in the hand of the user 90. |
| | | Examples of near-eye apparatuses 114 include smart phones, tablet |
| | | computers, camera eye-pieces and displays, microscope eye-pieces |
| | | and displays, gun scopes, and other similar devices. |
| 115 | Visor | An apparatus 110 implementing an embodiment of a visor system 105. |
| | Apparatus | The visor apparatus 115 is worn on the head 94 of the user 90. The |
| | | visor apparatus 115 can also be referred simply as a visor 115. |
| 116 | VRD Visor | An apparatus 110 in a VRD visor system 105. Unlike a visor apparatus |
| | Apparatus | 115, the VRD visor apparatus 116 includes a virtual retinal display that |
| | | projects the visual image 200 directly on the eyes 92 of the user 90. |
| 120 | Operating | Some embodiments of the system 100 can be implemented in such a |
| | Modes | way as to support distinct manners of operation. In some |
| | | embodiments of the system 100, the user 90 can explicitly or implicitly |
| | | select which operating mode 120 controls. In other embodiments, the |
| | | system 100 can determine the applicable operating mode 120 in |
| | | accordance with the processing rules of the system 100. In still other |
| | | embodiments, the system 100 is implemented in such a manner that |
| | | supports only one operating mode 120 with respect to a potential |
| | | feature. For example, some systems 100 can provide users 90 with a |
| | | choice between an immersion mode 121 and an augmentation mode |
| | | 122, while other embodiments of the system 100 may only support |
| | | one mode 120 or the other. |
| 121 | Immersion | An operating mode 120 of the system 100 in which the outside world |
| | | is at least substantially blocked off visually from the user 90, such that |
| | | the images 880 displayed to the user 90 are not superimposed over |
| | | the actual physical environment of the user 90. In many |
| | | circumstances, the act of watching a movie is intended to be an |
| | | immersive experience. |
| 122 | Augmentation | An operating mode 120 of the system 100 in which the image 880 |
| | | displayed by the system 100 is added to a view of the physical |
| | | environment of the user 90, i.e. the image 880 augments the real |
| | | world. Google Glass is an example of an electronic display that can |
| | | function in an augmentation mode. |
| 123 | Sensing | An operating mode 120 of the system 100 in which the system 100 |
| | | captures information about the user 90 through one or more sensors. |
| | | Examples of different categories of sensing can include eye tracking |
| | | pertaining to the user's interaction with the displayed image 880, |
| | | biometric scanning such as retina scans to determine the identity of |
| | | the user 90, and other types of sensor readings/measurements. |
| 124 | Non-Sensing | An operating mode 120 of the system 100 in which the system 100 |
| | | does not capture information about the user 90 or the user's |
| | | experience with the displayed image 880. |
| 140 | Display | A technology for displaying images. The system 100 can be |
| | Technology | implemented using a wide variety of different display technologies. |
| 141 | DLP System | An embodiment of the system 100 that utilizes digital light processing |
| | | (DLP) to compose an image 880 from light 800. |
| 142 | LCD System | An embodiment of the system 100 that utilizes liquid crystal display |
| | | (LCD) to compose an image 880 from light 800. |
| 143 | LCOS System | An embodiment of the system 100 that utilizes liquid crystal on silicon |
| | | (LCOS) to compose an image 880 from light 800. |
| 150 | Supporting | Regardless of the context and configuration, a system 100 like any |
| | Components | electronic display is a complex combination of components and |
| | | processes. Light 800 moves quickly and continuously through the |
| | | system 100. Various supporting components 150 are used in different |
| | | embodiments of the system 100. A significant percentage of the |
| | | components of the system 100 can fall into the category of supporting |
| | | components 150 and many such components 150 can be referred to |
| | | as “conventional optics”. Supporting components 160 are necessary |
| | | in any implementation of the system 100 in that light 800 is an |
| | | important resource that must be controlled, constrained, directed, and |
| | | focused to be properly harnessed in the process of transforming light |
| | | 800 into an image 880 that is displayed to the user 90. The text and |
| | | drawings of a patent are not intended to serve as product blueprints. |
| | | One of ordinary skill in the art can devise multiple variations of |
| | | supplementary components 150 that can be used in conjunction with |
| | | the innovative elements listed in the claims, illustrated in the drawings, |
| | | and described in the text. |
| 151 | Mirror | An object that possesses at least a non-trivial magnitude of reflectivity |
| | | with respect to light. Depending on the context, a particular mirror |
| | | could be virtually 100% reflective while in other cases merely 50% |
| | | reflective. Mirrors 151 can be comprised of a wide variety of different |
| | | materials. |
| 152 | Dichroic Mirror | A mirror 151 with significantly different reflection or transmission |
| | | properties at two different wavelengths. |
| 160 | Lens | An object that possesses at least a non-trivial magnitude of |
| | | transmissivity. Depending on the context, a particular lens could be |
| | | virtually 100% transmissive while in other cases merely about 50% |
| | | transmissive. A lens 160 is often used to focus light 800. |
| 170 | Collimator | A device that narrows a beam of light 800. |
| 180 | Plate | An object that possesses a non-trivial magnitude of reflectiveness and |
| | | transmissivity. |
| 190 | Processor | A central processing unit (CPU) that is capable of carrying out the |
| | | instructions of a computer program. The system 100 can use one or |
| | | more processors 190 to communicate with and control the various |
| | | components of the system 100. |
| 191 | Power Source | A source of electricity for the system 100. Examples of power sources |
| | | include various batteries as well as power adaptors that provide for a |
| | | cable to provide power to the system 100. |
| 200 | Illumination | A collection of components used to supply light 800 to the imaging |
| | Assembly | assembly 300. Common example of components in the illumination |
| | | assembly 200 include light sources 210 and diffusers 282. The |
| | | illumination assembly 200 can also be referred to as an illumination |
| | | subsystem 200. |
| 210 | Light Source | A component that generates light 800. There are a wide variety of |
| | | different light sources 210 that can be utilized by the system 100. |
| 211 | Multi-Prong | A light source 210 that includes more than one illumination element. |
| | Light Source | A 3-colored LED lamp 213 is a common example of a multi-prong light |
| | | source 212. |
| 212 | LED Lamp | A light source 210 comprised of a light emitting diode (LED). |
| 213 | 3 LED Lamp | A light source 210 comprised of three light emitting diodes (LEDs). In |
| | | some embodiments, each of the three LEDs illuminates a different |
| | | color, with the 3 LED lamp eliminating the use of a color wheel 240. |
| 214 | Laser | A light source 210 comprised of a device that emits light through a |
| | | process of optical amplification based on the stimulated emission of |
| | | electromagnetic radiation. |
| 215 | OLED Lamp | A light source 210 comprised of an organic light emitting diode |
| | | (OLED). |
| 216 | CFL Lamp | A light source 210 comprised of a compact fluorescent bulb. |
| 217 | Incandescent | A light source 210 comprised of a wire filament heated to a high |
| | Lamp | temperature by an electric current passing through it. |
| 218 | Non-Angular | A light source 210 that projects light that is not limited to a specific |
| | Dependent Lamp | angle. |
| 219 | Arc Lamp | A light source 210 that produces light by an electric arc. |
| 230 | Light Location | A location of a light source 210, i.e. a point where light originates. |
| | | Configurations of the system 100 that involve the projection of light |
| | | from multiple light locations 230 can enhance the impact of the |
| | | diffusers 282. |
| 240 | Color Wheel | A spinning wheel that can be used in a DLP system 141 to infuse color |
| | | into the image 880. |
| 280 | Diffuser | A collection of components and processes that are used to diffuse light |
| | Subassembly | 800. The diffuser assembly 280 includes two or more diffusers 282 |
| | | separated by one or more gaps 290. |
| 282 | Diffuser | An object that diffuses light when light 800 passes through it. Diffusers |
| | | 282 can be made of a wide variety of different materials and |
| | | combinations of materials. Diffusers 282 can be film/plastic diffusers |
| | | 283, paper diffusers 284, glass diffusers 285, coating diffusers 286, or |
| | | virtually any multi-textured surface 287. |
| 283 | Film Diffuseror | A diffuser 282 comprised of a film or plastic material. |
| | Plastic Diffuser | |
| 284 | Paper Diffuser | A diffuser 282 comprised of a paper material. |
| 285 | Glass Diffuser | A diffuser 282 comprised of a glass material. |
| 286 | Coating | A diffuser 282 comprised of a coating on at otherwise at least semi- |
| | Diffuser | transparent material. |
| 287 | Multi-Textured | A diffuser 282 comprised of an otherwise at least semi-transparent |
| | Surface | material with a multi-textured surface. |
| 290 | Gap | A distance between two diffusers 282. The gap 290 can be comprised |
| | | of air (an air gap 291), of glass (a glass gap 292), or any other at least |
| | | somewhat transparent material. |
| 291 | Air Gap | A gap 290 comprised of empty space, i.e. air. |
| 292 | Glass Gap | A gap 290 comprised of glass. |
| 300 | Imaging | A collective assembly of components, subassemblies, processes, and |
| | Assembly | light 800 that are used to fashion the image 880 from light 800. In |
| | | many instances, the image 880 initially fashioned by the imaging |
| | | assembly 300 can be modified in certain ways as it is made accessible |
| | | to the user 90. The modulator 320 is the component of the imaging |
| | | assembly 300 that is primarily responsible for fashioning an image 880 |
| | | from the light 800 supplied by the illumination assembly 200. |
| 310 | Prism | A substantially transparent object that is often has triangular bases. |
| | | Some display technologies 140 utilize one or more prisms 310 to direct |
| | | light 800 to a modulator 320 and to receive an image 880 from the |
| | | modulator 320. |
| 311 | TIR Prism | A total internal reflection (TIR) prism 310 used in a DLP 141 to direct |
| | | light to and from a DMD 324. |
| 312 | RTIR Prism | A reverse total internal reflection (RTIR) prism 310 used in a DLP 141 |
| | | to direct light to and from a DMD 324. |
| 320 | Modulator or | A device that regulates, modifies, or adjusts light 800. Modulators 320 |
| | Light Modulator | form an image 880 from the light 800 supplied by the illumination |
| | | assembly 200. |
| 321 | Transmissive- | A modulator 320 that fashions an image 880 from light 800 utilizing a |
| | Based Light | transmissive property of the modulator 320. Common examples of |
| | Modulator | reflection-based light modulators 322 include LCDs 330 and LCOSs 340. |
| 322 | Reflection- | A modulator 320 that fashions an image 880 from light 800 utilizing a |
| | Based Light | reflective property of the modulator 320. Common examples of |
| | Modulator | reflection-based light modulators 322 include DMDs 324 and LCOSs 340. |
| 324 | DMD | A reflection-based light modulator 322 commonly referred to as a |
| | | digital micro mirror device. A DMD 324 is typically comprised of a |
| | | several thousand microscopic mirrors arranged in an array on a |
| | | processor 190, with the individual microscopic mirrors corresponding |
| | | to the individual pixels in the image 880. |
| 330 | LCD Panel or | A light modulator 320 in an LCD (liquid crystal display). A liquid crystal |
| | LCD | display that uses the light modulating properties of liquid crystals. Each |
| | | pixel of an LCD typically consists of a layer of molecules aligned |
| | | between two transparent electrodes, and two polarizing filters (parallel |
| | | and perpendicular), the axes of transmission of which are (in most of |
| | | the cases) perpendicular to each other. Without the liquid crystal |
| | | between the polarizing filters, light passing through the first filter would |
| | | be blocked by the second (crossed) polarizer. Some LCDs are |
| | | transmissive while other LCDs are transflective. |
| 340 | LCOS Panel or | A light modulator 320 in an LCOS (liquid crystal on silicon) display. A |
| | LCOS | hybrid of a DMD 324 and an LCD 330. Similar to a DMD 324, except |
| | | that the LCOS 326 uses a liquid crystal layer on top of a silicone |
| | | backplane instead of individual mirrors. An LCOS 244 can be |
| | | transmissive or reflective. |
| 350 | Dichroic | A device used in an LCOS or LCD display that combines the different |
| | Combiner Cube | colors of light 800 to formulate an image 880. |
| 400 | Projection | A collection of components used to make the image 880 accessible to |
| | Assembly | the user 90. The projection assembly 400 includes a display 410. The |
| | | projection assembly 400 can also include various supporting |
| | | components 150 that focus the image 880 or otherwise modify the |
| | | interim image 850 transforming it into the image 880 that is displayed |
| | | to one or more users 90. The projection assembly 400 can also be |
| | | referred to as a projection subsystem 400. |
| 410 | Display or | An assembly, subassembly, mechanism, or device by which visual |
| | Screen | image 200 is made accessible to the user 90. The display component |
| | | 120 can be in the form of a panel 122 that is viewed by the user 90 or |
| | | a screen 126 onto which the visual image 200 is projected onto by a |
| | | projector 124. In some embodiments, the display component 120 is a |
| | | retinal projector 128 that projects the visual image 200 directly onto |
| | | the eyes 92 of the user 90. |
| 412 | Active Screen | A display screen 410 powered by electricity that displays the image 880. |
| 414 | Passive Screen | A non-powered surface on which the image 880 is projected. A |
| | | conventional movie theater screen is a common example of a passive |
| | | screen 412. |
| 416 | Eyepiece | A display 410 positioned directly in front of the eye 92 of an individual |
| | | user 90. |
| 418 | VRD Eyepiece | An eyepiece 416 that provides for directly projecting the image 880 on |
| | or VRD Display | the eyes 92 of the user 90. A VRD eyepiece 418 can also be referred |
| | | to as a VRD display 418. |
| 800 | Light | Light is electromagnetic radiation. Not all light 800 is visible to the |
| | | human eye, but the image 890 displayed by the system 100 is visible |
| | | to the human eye. Light 800 is a component of the system 100 in the |
| | | sense that the system 100 uses light 800 to make the image 890 that |
| | | is displayed to users 90. Light can be partially coherent light 803 or |
| | | non-coherent light 804. The use of non-coherent light 804 to make |
| | | the image 890 can be advantageous, because non-coherent light 804 |
| | | appears more natural to the user 90 and provides for a superior |
| | | mixture of color. |
| 800 | Light | Light 800 is the media through which an image is conveyed, and light |
| | | 800 is what enables the sense of sight. Light is electromagnetic |
| | | radiation that is propagated in the form of photons. Light can be |
| | | coherent light 802, partially coherent light 803, or non-coherent light 804. |
| 802 | Coherent Light | Light 800 in which the phases of all electromagnetic waves at each |
| | | point on a line normal to the direction of the beam are identical or at |
| | | least substantially identical. The purpose of using diffuser elements |
| | | 282 in the system 100 is to reduce the coherency of the light 800 used |
| | | to convey the image 880. |
| 803 | Partially | Light 800 that is at least partially coherent, a category that includes |
| | Coherent Light | coherent light 802. |
| 804 | Non-Coherent | Light 800 with sufficiently low coherency as to appear natural to the |
| | Light | human eye. |
| 806 | Diffused Light | Light that has gone through a diffuser 282. |
| 808 | Multiply | Light 800 that has passed through two or more diffusers 282. |
| | Diffused Light | |
| 830 | Metrics | There are a variety of objective measurements that can be taken and |
| | | analyzed with respect to light 800 and the images 880 created from |
| | | that light. |
| 832 | Coherence | A quantitative metric representing the relative coherence or partial |
| | Metric | coherence of light. |
| 834 | Color Mix | A quantitative metric representing the mixture of color. |
| | Metric | |
| 836 | Optical Efficiency | A quantitative metric representing the optical efficiency of the system 100. |
| | Metric | |
| 840 | Media Content | The image 880 displayed to the user 90 by the system 100 can in |
| | | many instances, be but part of a broader media experience. A unit of |
| | | media content 840 will typically include visual attributes 841 and |
| | | acoustic attributes 842. Tactile attributes 843 are not uncommon in |
| | | certain contexts. It is anticipated that the olfactory attributes 844 and |
| | | gustatory attributes 845 may be added to media content 840 in the |
| | | future. |
| 841 | Visual | Attributes pertaining to the sense of sight. The core function of the |
| | Attributes | system 100 is to enable users 90 to experience visual content such as |
| | | images 880 or video 890. In many contexts, such visual content will |
| | | be accompanied by other types of content, most commonly sound or |
| | | touch. In some instances, smell or taste content may also be included |
| | | as part of the media content 840. |
| 842 | Acoustic | Attributes pertaining to the sense of sound. The core function of the |
| | Attributes | system 100 is to enable users 90 to experience visual content such as |
| | | images 880 or video 890. However, such media content 840 will also |
| | | involve other types of senses, such as the sense of sound. The system |
| | | 100 and apparatuses 110 embodying the system 100 can include the |
| | | ability to enable users 90 to experience tactile attributes 843 included |
| | | with other types of media content 840. |
| 843 | Tactile | Attributes pertaining to the sense of touch. Vibrations are a common |
| | Attributes | example of media content 840 that is not in the form of sight or sound. |
| | | The system 100 and apparatuses 110 embodying the system 100 can |
| | | include the ability to enable users 90 to experience tactile attributes |
| | | 843 included with other types of media content 840. |
| 844 | Olfactory | Attributes pertaining to the sense of smell. It is anticipated that future |
| | Attributes | versions of media content 840 may include some capacity to engage |
| | | users 90 with respect to their sense of smell. Such a capacity can be |
| | | utilized in conjunction with the system 100, and potentially integrated |
| | | with the system 100. The iPhone app called oSnap is a current |
| | | example of gustatory attributes 845 being transmitted electronically. |
| 845 | Gustatory | Attributes pertaining to the sense of taste. It is anticipated that future |
| | Attributes | versions of media content 840 may include some capacity to engage |
| | | users 90 with respect to their sense of taste. Such a capacity can be |
| | | utilized in conjunction with the system 100, and potentially integrated |
| | | with the system 100. |
| 848 | Media Player | The system 100 for displaying the image 880 to one or more users 90 |
| | | may itself belong to a broader configuration of applications and |
| | | systems. A media player 848 is device or configuration of devices that |
| | | provide the playing of media content 840 for users. Examples of |
| | | media players 848 include disc players such as DVD players and BLU- |
| | | RAY players, cable boxes, tablet computers, smart phones, desktop |
| | | computers, laptop computers, television sets, and other similar |
| | | devices. Some embodiments of the system 100 can include some or |
| | | all of the aspects of a media player 848 while other embodiments of |
| | | the system 100 will require that the system 100 be connected to a |
| | | media player 848. For example, in some embodiments, users 90 may |
| | | connect a VRD apparatus 116 to a BLU-RAY player in order to access |
| | | the media content 840 on a BLU-RAY disc. In other embodiments, |
| | | the VRD apparatus 116 may include stored media content 840 in the |
| | | form a disc or computer memory component. Non-integrated versions |
| | | of the system 100 can involve media players 848 connected to the |
| | | system 100 through wired and/or wireless means. |
| 850 | Interim Image | The image 880 displayed to user 90 is created by the modulation of |
| | | light 800 generated by one or light sources 210 in the illumination |
| | | assembly 200. The image 880 will typically be modified in certain |
| | | ways before it is made accessible to the user 90. Such earlier versions |
| | | of the image 880 can be referred to as an interim image 850. |
| 852 | Subframe | A portion of an image 880 or interim image 850. A DLP projector will |
| | | illuminate different pixels at different times based on color. |
| 854 | Subframe | The sequence at which different subframes 852 are illuminated with |
| | Illumination | different colors of light (800). A DLP projector has traditionally used a |
| | Sequence | color wheel 240 to implement the subframe illumination sequence 854. |
| 880 | Image | A visual representation such as a picture or graphic. The system 100 |
| | | performs the function of displaying images 880 to one or more users |
| | | 90. During the processing performed by the system 100, light 800 is |
| | | modulated into an interim image 850, and subsequent processing by |
| | | the system 100 can modify that interim image 850 in various ways. At |
| | | the end of the process, with all of the modifications to the interim image |
| | | 850 being complete the then final version of the interim image 850 is |
| | | no longer a work in process, but an image 880 that is displayed to the |
| | | user 90. In the context of a video 890, each image 880 can be referred |
| | | to as a frame 882. |
| 882 | Frame | An image 880 that is a part of a video 890. |
| 890 | Video | In some instances, the image 880 displayed to the user 90 is part of a |
| | | sequence of images 880 can be referred to collectively as a video 890. |
| | | Video 890 is comprised of a sequence of static images 880 |
| | | representing snapshots displayed in rapid succession to each other. |
| | | Persistence of vision in the user 90 can be relied upon to create an |
| | | illusion of continuity, allowing a sequence of still images 880 to give |
| | | the impression of motion. The entertainment industry currently relies |
| | | primarily on frame rates between 24 FPS and 30 FPS, but the system |
| | | 100 can be implemented at faster as well as slower frame rates. |
| 900 | Method | A process for displaying an image 880 to a user 90. |
| 910 | Illumination | A process for generating light 800 for use by the system 100. The |
| | Method | illumination method 910 is a process performed by the illumination |
| | | assembly 200. |
| 920 | Imaging | A process for generating an interim image 850 from the light 800 |
| | Method | supplied by the illumination assembly 200. The imaging method 920 can |
| | | also involve making subsequent modifications to the interim image 850. |
| 930 | Display Method | A process for making the image 880 available to users 90 using the |
| | | interim image 850 resulting from the imaging method 920. The display |
| | | method 930 can also include making modifications to the interim image 850. |

1. A system (100) for displaying an image (880) to a user (90), said system (100) comprising:
an illumination assembly (200) that provides for supplying a plurality of light (800) to an imaging assembly (300);
said imaging assembly (300) that provides for creating said image (880) from said light (800);
a diffuser subassembly (280) that provides for reducing the coherence of said light (800), wherein said diffuser subassembly (280) includes a plurality of diffusers (282) separated by a gap (290).

2. The system (100) of claim 1, wherein said image (880) has a coherence metric (832) that is at least about 5% less than said light (800) supplied by said light source (210) and wherein said image (880) has a color mix metric (834) that is greater than about 5% than said light (800) supplied by said imaging assembly (300).

3. The system (100) of claim 1, wherein said illumination assembly (200) includes said diffuser subassembly (280), said system (100) further comprising a projection subsystem (400) that provides for directing said image (880) to the user (90).

4. The system (100) of claim 1, wherein said plurality of diffusers (282) include at least one of: (a) a film diffuser (283); (b) a paper diffuser (282); and (c) a glass diffuser (284).

5. The system (100) of claim 1, wherein said gap (290) is an air gap (291).

6. The system (100) of claim 1, wherein said gap (290) is a glass gap (292).

7. The system (100) of claim 1, wherein said illumination assembly (200) includes a 3 LED lamp (213) for supplying said light (800).

8. The system (100) of claim 1, wherein said illumination assembly (200) includes a non-angular dependent lamp (219).

9. The system (100) of claim 1, wherein said system (100) is a DLP system (141).

10. The system (100) of claim 1, wherein said system (100) is a personal system (103).

11. The system (100) of claim 1, wherein said system (100) is a visor apparatus (115).

12. The system (100) of claim 1, wherein said system (100) is a VRD visor apparatus (116) worn by the user (90).

13. The system (100) of claim 1, wherein said diffuser subassembly (280) provides for reducing the coherence of said light (800) by at least about 10%.

14. The system (100) of claim 1, wherein said diffuser subassembly (280) provides for reducing the coherence of said light (800) by at least about 30%, and wherein said light (800) in said image (880) is modified by said projection assembly (400).

15. The system (100) of claim 1, wherein said illumination subassembly (200) includes said diffuser subassembly (280), wherein said gap (290) is at least about 1 mm in length, and wherein said light (800) in said displayed image (880) is at least 10% less coherent than said light (800) before said light (800) is diffused by said diffuser subassembly (280).

16. A system (100) for displaying an image (880) to a user (90), said system (100) comprising:
an illumination assembly (200) that includes:
a light source (210) that provides for generating a plurality of light (800); and
a plurality of diffusers (282) separated by a gap (290) that provide for diffusing said light (800);
an imaging assembly (300) that provides for creating said image (880) from said light (800) supplied by said illumination assembly (200) and diffused by said plurality of diffusers (282); and
a projection assembly (400) that provides for directing said image (880) to the user (90).

17. The system (100) of claim 16, wherein said image (880) has a coherence metric (832) that is at least about 10% than said light (800) provided by said illumination assembly (200), wherein said image (880) has a color mix metric (834) that is at least about 5% greater than said light (800) provided by said illumination assembly (200), and wherein said gap (290) is no longer than about 10 mm in length.

18. The system (100) of claim 16, wherein said system (100) is a VRD visor apparatus (116) worn by the user (90).

19. A method (900) for displaying an image (880) to a user (90), said method (900) comprising:
generating (912) a plurality of light (800) from a light source (210);
diffusing (914) the said light (800) with a first diffuser (282);
diffusing (916) said light (800) with a second diffuser (282); and
creating (920) said image (880) from said light (800) from said second diffuser (282);
wherein a gap (290) separates said first diffuser (282) and said second diffuser (282).

20. The method (900) of claim 19, wherein said gap (290) is no longer than about 10 mm, wherein said diffusers (282) are not substantially curved, wherein said image (880) is projected directly onto a plurality of eyes (92) of the user (90), and wherein said image (880) is modified after said image (880) is created but before said image (880) is displayed to the user (90).
